(19) United States
(12) Patent Application Publication
(10) Pub. No.: US 2025/0259467 A1
(43) Pub. Date: Aug. 14, 2025

(54) IMAGE INSPECTION DEVICE

(71) Applicant: Keyence Corporation, Osaka (JP)

(72) Inventor: Tsubasa TERASHIGE, Osaka (JP)

(73) Assignee: Keyence Corporation, Osaka (JP)

(21) Appl. No.: 19/037,339

(22) Filed: Jan. 27, 2025

(30) Foreign Application Priority Data
Feb. 8, 2024 (JP) 2024-017579
Mar. 18, 2024 (JP) 2024-042628

(51) Int. Cl. G06V 30/19; G06T 7/194; G06V 30/18

(52) U.S. Cl. CPC G06V 30/19173; G06T 7/194; G06V 30/18057

(57) ABSTRACT

An image inspection device includes a control unit configured to execute a pre-trained character recognition model and functions as a learning execution unit and a learning data generation unit. The learning data generation unit generates learning data that includes character type information, and size information. The learning execution unit updates the pre-trained character recognition model so as to classify an image area into added character type classes corresponding to the combination of the character type and the size.

### CROSS-REFERENCE TO RELATED APPLICATIONS

The present application claims foreign priority based on Japanese Patent Application No. 2024-017579, filed Feb. 8, 2024, and No. 2024-042628, filed Mar. 18, 2024, the contents of which are incorporated herein by references.

### BACKGROUND OF THE INVENTION

### 1. Technical Field

The present disclosure relates to an image inspection device implemented with a trained network that performs classification tasks for character recognition.

### 2. Description of the Related Art

For example, in the FA industry, image inspection devices that replace the process of human visual inspection of workpieces are widely known. The image inspection device captures workpiece images and judges the captured images based on certain criteria. When the image inspection device is an image sensor, the judgment result is output to external devices such as a programmable logic controller (PLC) via I/O output.

When the criteria used for the judgment of the image inspection device are based on certain image features, even changes in image features that do not affect the results of visual inspections by humans may potentially influence the judgment results of the image inspection device.

Therefore, in order to obtain judgment results closer to those of visual inspections, an image inspection device utilizing an image recognition model obtained through machine learning is known, for example, as disclosed in JP 2020-187072 A. In the image inspection device of JP 2020-187072 A, a learning device is generated that identifies good product images and defective product images by learning good product images with attributes assigned as good products and defective product images with attributes assigned as defective products, and it is configured to input newly acquired images into the learning device during operation to perform quality judgment.

### SUMMARY OF THE INVENTION

By the way, there is a device equipped with character recognition (OCR) that recognizes the character image, which is the character portion of the captured image of the work with characters assigned, identifies the characters on the work, and determines whether the corresponding characters conform to the judgment criteria using an image recognition model.

As a recognition method using OCR, there is a method called the sliding window method, for example. In the sliding window method, first, the size for extracting characters from the image is determined. For example, on an image captured of an actual workpiece with characters, a frame is set to enclose the characters on the workpiece. The size of this frame becomes the character extraction size. After the character extraction size is determined, when the OCR target image is input during operation, the OCR target image is extracted into multiple image areas based on the predetermined character extraction size. Each of the extracted multiple image areas undergoes verification to determine whether it has similar features to any character, and for example, if a certain area is determined to have the features of “A” (or has features similar to “A” to the extent that it can be judged as class “A” compared to other classes), that area is recognized as an image of the character “A.” At this time, the verification target of the features is slightly shifted for verification, so conceptually, the verification target frame (window) slides, hence it is called the sliding window method.

However, in the sliding window method, in order to determine which character corresponds to the features of the area of the extracted size, there are cases where character images with different sizes depending on the character type (for example, the “I” in proportional font or a period) are extracted as character images that include adjacent characters, which may lower the recognition accuracy.

In OCR, there may be cases where it is desired to increase the types of character sizes that can be recognized by the image recognition model. However, in the case of the sliding window method, it is necessary to scan and classify features while changing the size of the window, which results in an enormous amount of computational processing.

The present disclosure is made in consideration of such points, and its purpose is to enable handling while reducing processing load even if the recognizable character size is increased.

According to one embodiment, an image inspection device execute a pre-trained character recognition model to classify an image area, which is a partial area in an input image data, into a first character type class.

The image inspection device includes a control unit that executes the pre-trained character recognition model and functions as a learning data generation unit that generates learning data and a learning execution unit that executes updating of the pre-trained character recognition model based on the learning data. The pre-trained character recognition model includes a feature extraction unit that extracts a feature from the input image data, the feature indicating a characteristic of an image data, and a character type output unit that outputs a character type based on the feature extracted by the feature extraction unit. The learning data generation unit generates the learning data that includes learning image data, specified position information indicating a relative position of a character in an image of the learning image data, specified character type information indicating the character type of the character located at the relative position, and specified size information indicating a size of the character in the image.

The learning execution unit updates the pre-trained character recognition model so as to classify the feature, the feature being extracted in a case that the learning image data is input to the feature extraction unit and corresponding to the relative position indicated by the specified position information, into a specified character type class corresponding to a combination of the character type indicated by the specified character type information and the size indicated by the specified size information.

According to this configuration, the learning data generated by the learning data generation unit includes not only the specified character type information indicating the character type but also the specified position information indicating the relative position of the characters in the learning image data and the specified size information indicating the size of the characters in the image. As a result, the learning execution unit learns the combination of the specified character size and the specified character type in the learning data as a new character type class, thereby reducing the learning load related to the character size while increasing the recognizable character sizes.

The control unit may be configured to have a convolutional operation network inference accelerator that performs operations of a convolutional neural network as the feature extraction unit.

The feature extraction unit may include a character type class feature extraction unit that extracts features related to the character type class of the image area, and a foreground-background feature extraction unit that extracts foreground features, which are features indicating whether the image area is foreground or background. In addition, it has a foreground output unit that determines whether the image area is foreground based on the foreground features, and the character type output unit can output a value indicating the character type of the image area based on the character type features corresponding to the image area determined to be foreground.

That is, for example, if a classifier that includes the background is used, any “character” class close to the “background” class will exist in the feature space handled by the classifier, and labeling such “characters” will cause all nearby “background” vectors to be classified into the corresponding “character” class. However, by narrowing down whether the image area is foreground or background and training as in this embodiment, such problems are less likely to occur, and the determination accuracy is improved.

The feature extraction unit may include a character type class feature extraction unit that extracts features related to the character type class of the image area, and a size feature extraction unit that extracts size features related to the size of the image area. In this case, the character type output unit can output the size of the character image in the image area based on the specified size included in the specified character type class when the character type class feature corresponds to the specified character type class that is a combination of the character type and the specified size.

The size output unit that outputs the size of the character image in the image area based on the size feature may be provided. In this case, the size output unit can output the size of the character image when the character type class feature does not belong to the specified character type class corresponding to the combination of the character type and the specified size.

As explained above, since the learning data includes specified character type information, specified position information indicating the relative position of characters in the image, and specified size information indicating the size of the characters, it is possible to learn the combination of character size and character type as a new character type class, thereby increasing the recognizable character sizes while reducing the learning load related to character size.

### BRIEF DESCRIPTION OF THE DRAWINGS

FIG. 1 is a diagram explaining the operation of the image inspection device according to an embodiment of the present invention.

FIG. 2 is a hardware configuration diagram of the image inspection device.

FIG. 3 is a functional block diagram within the DSP.

FIG. 4 is a flowchart showing an example of the procedure during the setting of the image inspection device.

FIG. 5 is a flowchart showing an example of the procedure during the setting of the inspection tool.

FIG. 6 is a flowchart showing an example of the procedure during the execution of the inspection.

FIG. 7 is a diagram showing the processing concept of the AI-OCR tool.

FIG. 8 is a diagram explaining the character types in pre-learning.

FIG. 9 is a diagram showing the character type output unit at the completion of pre-learning.

FIG. 10 is a diagram showing the character type output unit at the completion of on-site learning.

FIG. 11 is a diagram showing a specific example of character recognition processing.

FIG. 12 is a diagram showing a specific example of dictionary registration processing.

FIG. 13 is a diagram explaining the case of additional learning of the same character that appears different.

FIG. 14 is a flowchart showing an example of the procedure for re-learning after the operation of the image inspection device.

FIG. 15 is a diagram showing an example of the operation result display screen.

FIG. 16 is a diagram showing an example of the additional learning window display.

FIG. 17 is a diagram showing an example of the screen displayed during additional learning.

FIG. 18 is a diagram showing an example of the character type selection window display.

FIG. 19 is a diagram corresponding to FIG. 17 showing the state where the character type is selected.

FIG. 20 is a diagram showing an example of the screen displayed when adding unregistered character types for additional learning.

FIG. 21 is a diagram showing an example of the screen displayed when registering character types in the user dictionary.

FIG. 22 is a diagram showing an example of the window for newly registering character types.

FIG. 23 is a diagram corresponding to FIG. 19 showing the newly registered character types.

FIG. 24 is a diagram showing an example of the screen displayed before starting additional learning.

FIG. 25 is a diagram showing an example of the screen displayed when confirming the results of additional learning.

FIG. 26 is a diagram showing an example of the screen displayed during operation when inspecting the date.

FIG. 27 is a diagram showing an example of the selection window that accepts the selection of the OCR mode.

FIG. 28 is a diagram showing an example of the screen displayed when specifying the template.

FIG. 29 is a diagram showing an example of the window for setting judgment conditions.

FIG. 30 is a diagram showing an example of the window for setting the date and time offset.

FIG. 31 is a diagram explaining the case of changing the master string for each imaging.

FIG. 32 is a diagram showing an example of the screen displayed when performing custom settings.

FIG. 33 is a diagram showing an example of the format setting window.

FIG. 34 is a diagram corresponding to FIG. 33 showing the case when separated by elements.

FIG. 35 is a diagram showing the screen displayed when setting the content of the elements.

FIG. 36 is a diagram showing the screen where the first selection window showing the options for the content of the elements is displayed.

FIG. 37 is a diagram showing the screen where the second selection window showing the options for the content of the elements is displayed.

FIG. 38 is a diagram showing an example of the count up/down setting window.

FIG. 39 is a diagram showing an example of the window for replacement settings.

FIG. 40 is a diagram showing an example of the linking window to link the notation of early, middle, and late parts of the month with the calendar.

FIG. 41 is a diagram showing an example of the batch input window.

FIG. 42 is a diagram showing the screen displayed when an image containing a string arranged in an arc shape is input.

FIG. 43 is a diagram corresponding to FIG. 42 showing the case when the phase of the string arranged in an arc shape changes.

FIG. 44 is a diagram showing an example of the arc setting window.

FIG. 45 is a diagram showing the screen displayed when performing additional learning using a test image with different phases of the string.

FIG. 46 is a diagram showing an example of the screen displayed during operation when inspecting a string arranged in an arc shape.

FIG. 47 is a diagram corresponding to FIG. 46 showing the case when part of the string arranged in an arc shape is missing.

FIG. 48 is a diagram showing an example of the additional learning confirmation window.

FIG. 49 is a diagram explaining the case when the box enclosing the characters to be learned during additional learning is moved.

### DETAILED DESCRIPTION

The following describes in detail the embodiments of the present invention based on the drawings. The description of the preferred embodiments below is essentially illustrative and is not intended to limit the present invention, its applications, or its uses.

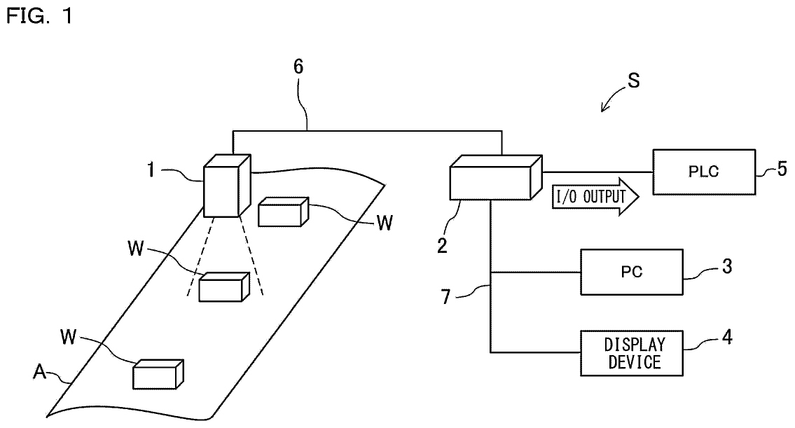

FIG. 1 is a diagram explaining the operation of the image inspection device S according to an embodiment of the present invention. The image inspection device S captures an image of the work W conveyed by the conveying means A according to the imaging settings, acquires a work image, and judges the acquired work image according to the judgment settings to output the inspection result using the judgment result as a sensor output to an external device. The external device can include, for example, a Programmable Logic Controller (PLC) 5, but it may also be a device other than PLC 5. The PLC 5 controls the conveying means A to separate the storage destination of the work W based on the received inspection result. The following explanation will describe the case where the external device is PLC 5. Note that the work W may also be a work that is not conveyed by the conveying means A.

The image inspection device S is equipped with an imaging unit 1 for capturing the work W, a control unit 2 to which image data captured by the imaging unit 1 is input, a PC (personal computer) 3 for setting the image inspection device S, and a display device 4 for displaying the setting screen, selection screen, work images, inspection results, and the like. The control unit 2 is capable of executing a trained model that performs a classification task into multiple character type classes for recognizing characters in an image area that is a part of the input image data. The control unit 2 executes sensor output to the PLC 5 according to the character recognition results from the trained model.

The image inspection device S is sometimes used to inspect the work W from various angles at various points of a manufacturing device or manufacturing line. Therefore, there may be multiple image inspection devices S installed in a single manufacturing device or manufacturing line, and it is conceivable that sufficient installation space and power supply cannot be secured. Thus, the image inspection device S requires miniaturization to fit the installation space and power saving to match the power supply, and to satisfy these requirements, the image inspection device S according to this embodiment is configured without a GPU. In other words, the control unit 2 is equipped with a pre-trained model that has been trained to a level capable of basic character recognition, but it is possible to achieve the desired classification accuracy without the user performing advanced additional learning that would recommend GPU usage. Furthermore, the fact that the user does not need to perform advanced learning means that the user does not need to prepare a GPU tailored for learning, which can shorten the time required for learning. It is also possible to install and operate a single image inspection device S on a manufacturing device or manufacturing line. Additionally, the image inspection device S can also be referred to as an image sensor.

(Structure of Imaging Unit) Imaging unit 1 is configured separately from control unit 2 and is installed so that it can capture the workpiece W from a desired direction. The workpiece W is sequentially conveyed by conveying means A into the imaging field of Imaging Unit 1.

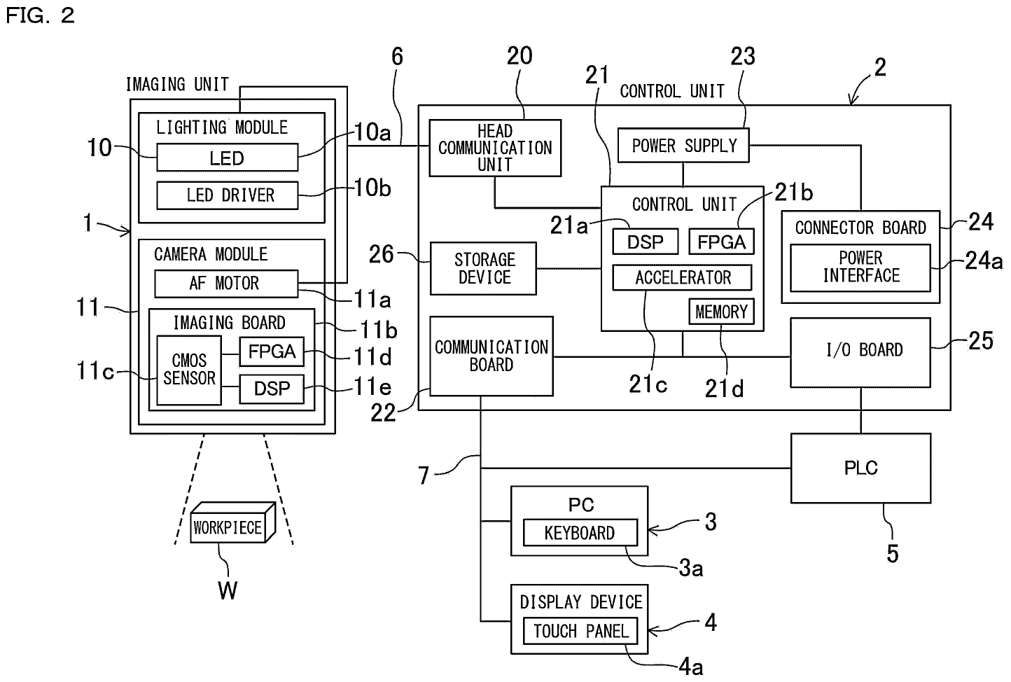

As shown in FIG. 2, the imaging unit 1 includes a lighting module 10 for illuminating the work W and a camera module 11 for capturing the work W illuminated by the lighting module 10.

The lighting module 10 includes an LED (light emitting diode) 10a that irradiates light toward the work W and an LED driver 10b that controls the light amount and light emission timing of the LED 10a. The LED driver 10b is connected to the head communication unit 20 of the control unit 2 (described later) and is controlled by the control unit 2's control unit 21 (described later).

The camera module 11 includes an AF motor 11a and an imaging board 11b. The AF motor 11a is a component that automatically focuses on the work W by driving a focusing lens of an optical system (not shown). The method of automatic focus is not particularly limited, and examples such as the contrast method can be mentioned.

The imaging board 11b is equipped with a CMOS sensor 11c, an FPGA 11d, and a DSP 11e. The CMOS sensor 11c is an image sensor that receives reflected light reflected from the work W, which is irradiated by the LED 10a. This CMOS sensor 11c is connected to the head communication unit 20 of the control unit 2 and is controlled by the control unit 21 of the control unit 2 to perform exposure processing for a predetermined time at a predetermined timing.

The FPGA 11d is a processing device capable of changing the internal processing content. The DSP 11e is a signal processing device. The light reception amount signal of the light receiving element possessed by the CMOS sensor 11c is output to the FPGA 11d for processing, and is also output to the DSP 11e for processing. The processing by the FPGA 11d and DSP 11e is not particularly limited, but various filter processing can be mentioned as examples. The image data processed by the FPGA 11d and DSP 11e is transmitted from the imaging unit 1 to the control unit 2.

The imaging unit 1 and the control unit 2 are connected via the communication cable 6. Therefore, the control unit 2 can be installed at a location away from the installation location of the imaging unit 1.

(Structure of PC) PC3 is composed of a general-purpose personal computer or the like. In this example, PC3 becomes usable by installing a predetermined program on the personal computer. PC3 includes input devices such as a keyboard 3a and a mouse (not shown). The user of the image inspection device S can perform setting operations and selection operations of the image inspection device S by operating the input devices of PC3. Specific setting operations and selection operations will be described later.

The communication board 22 of PC3 and control unit 2 is connected to each other in a communicable manner, and information based on the setting operation by the user is transmitted from PC3 to control unit 2. In addition, image data of work W and inspection results output from control unit 2 can be received by PC3. PC3 and control unit 2 are connected via communication cable 7. Therefore, PC3 can be installed at a location away from the installation location of control unit 2.

(Structure of Display Device 4) The display device 4 is composed of, for example, a liquid crystal display or an organic EL display. In this example, the display device 4 includes a touch panel 4a. The touch panel 4a is a member capable of detecting operations by the user's finger. The form of the touch panel 4a is not particularly limited, and examples include capacitive type and infrared type. The display device 4 and the communication board 22 of the control unit 2 are connected to each other in a manner that allows mutual communication. The operation information of the touch panel 4a by the user is transmitted from the display device 4 to the control unit 2. In addition, image data of the work W output from the control unit 2 can be received by the display device 4. The display device 4 and the control unit 2 are connected via a communication cable 7. Therefore, the display device 4 can be installed at a location away from the installation location of the control unit 2.

Moreover, PC3 and display device 4 may be configured as a single unit. For example, display device 4 may be configured with the display device possessed by PC3. In this case, the main body of PC3 and display device 4 may be integrated or may be separate. In addition, in this example, communication board 22 and PLC 5 are connected via communication cable 7.

(Configuration of Control Unit 2) As shown in FIG. 2, the control unit 2 includes a head communication unit 20, a control unit 21, a communication board 22, a power supply 23, a connector board 24, an I/O board 25, and a storage device (storage unit) 26. The head communication unit 20 is connected to the control unit 21 and is the part that performs mutual communication between the control unit 21 and the imaging unit 1. The control signal of the imaging unit 1 output from the control unit 21 is transmitted to the imaging unit 1 via the head communication unit 20. The control signal of the imaging unit 1 includes a signal that controls the light emission timing and light emission amount of the LED 10a, and a signal that controls the AF motor 11a and the imaging board 11b. In addition, the image data obtained by the imaging unit 1 is transmitted to the control unit 21 via the head communication unit 20 after being output from the imaging unit 1.

The control unit 21 includes a DSP 21a and an FPGA 21b that perform various signal processing, an accelerator 21c for speeding up processing, and a memory 21d composed of RAM, ROM, etc. The specific configuration of the control unit 21 will be described later.

The communication board 22 is connected to the control unit 21 and is a component that performs mutual communication between the control unit 21, PC3, display device 4, and PLC 5.

The connector board 24 includes a power interface 24a. The power interface 24a is connected to a power cable (not shown) for supplying power from the outside. The connector board 24 is connected to the power supply 23, and the power supplied to the power interface 24a from the outside is adjusted to a predetermined voltage by the power supply 23 before being supplied to the control unit 21. The power supplied to the control unit 21 is supplied to the imaging unit 1 via the head communication unit 20.

The I/O board 25 is connected to the control unit 21. The inspection results output from the control unit 21 are input to the PLC 5 via the I/O board 25.

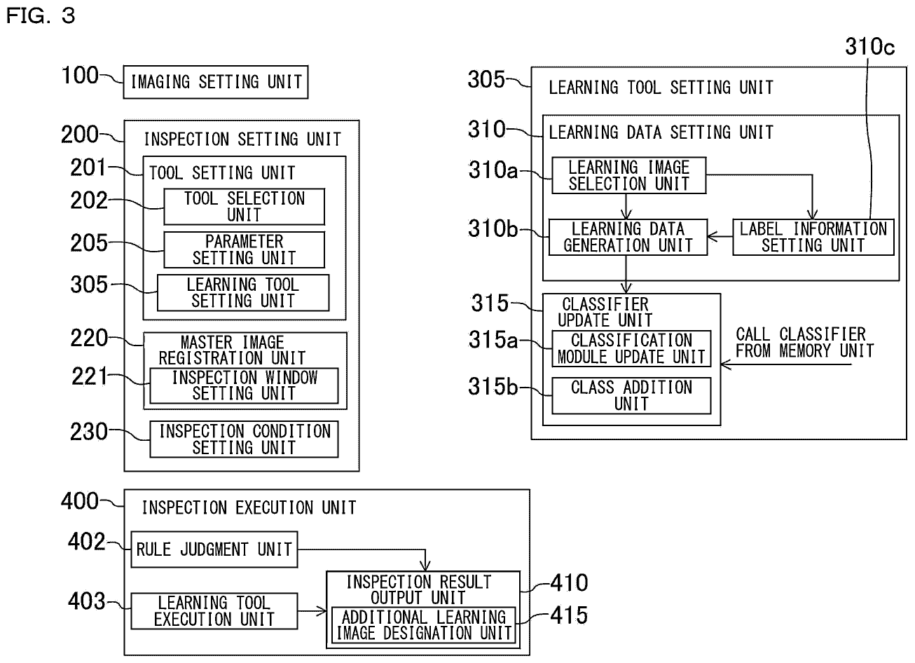

(Details of DSP21a) FIG. 3 is a functional block diagram of the control unit 2 having the control section 21. The control section 21 includes an imaging setting unit 100, an inspection setting unit 200, and an inspection execution unit 400.

The imaging setting unit 100 is a part that sets the imaging setting parameters and reflects the set imaging setting parameters during the imaging of the work W. The imaging setting parameters include multiple parameters such as the timing of illumination by the illumination module 10, brightness (light emission amount), exposure time by the camera module 11, and focus (focal position) of the camera module 11. When setting the image inspection device S, the imaging setting unit 100 displays a GUI (graphical user interface) related to the setting of the imaging setting parameters on the display device 4. Although not shown, the GUI related to the setting of the imaging setting parameters has areas where the brightness of the illumination, exposure time, focus, etc. can be set individually. When the user inputs each parameter on the GUI using a touch panel 4a or a keyboard 3a, the imaging setting unit 100 accepts the setting operation by the user and outputs each parameter to, for example, the storage device 26 to store it in the corresponding storage device 26. It is possible to read each parameter from the storage device 26 as needed.

When acquiring image data of the work W, the imaging setting unit 100 outputs the setting data including the imaging setting parameters to the camera module 11. When the camera module 11 receives the setting data, it sets the imaging setting parameters included in the received setting data to be reflected during imaging within the camera module 11. When the camera module 11 receives the imaging trigger signal, it illuminates the work W according to the imaging setting parameters and captures the image data of the work W.

The inspection setting unit 200 includes a tool setting unit 201, a master image registration unit 220, and an inspection condition setting unit 230. The tool setting unit 201 has a tool selection unit 202, a parameter setting unit 205, and a learning tool setting unit 305. The tool selection unit 202 is a part that allows the user to select the tool set by the user. When setting the image inspection device S, the tool selection unit 202 displays a GUI related to the selection of tools on the display device 4. Although not shown, the GUI related to the selection of tools has an area where the user can select the desired tool from multiple tools. When the user selects any tool on the GUI using a touch panel 4a or a keyboard 3a, the tool selection unit 202 accepts the selection operation by the user and outputs the selected tool to, for example, the storage device 26 to store it in the corresponding storage device 26. It is possible to read the selected tool from the storage device 26 as needed.

When the tool selected in the tool selection unit 202 is a rule-based tool, the information regarding the tool selected in the tool selection unit 202 is output to the parameter setting unit 205 as selected tool information. When setting the image inspection device S, the parameter setting unit 205 displays a GUI (Graphical User Interface) related to the setting of tool parameters on the display device 4. The tool parameters are parameters that can be set for each tool. When the user sets the tool parameters on the GUI using a touch panel 4a or a keyboard 3a, the parameter setting unit 205 accepts the setting operation by that user and outputs the tool parameters to, for example, the storage device 26 to store them in the storage device 26. It is possible to read the tool parameters from the storage device 26 as needed. The learning tool setting unit 305 will be described later.

The master image registration unit 220 is a part that registers the captured image I1 as the master image I2. Specifically, the master image registration unit 220 presents the captured image I1 to the user by incorporating it into the GUI and displaying it on the display device 4.

When the user wants to register the captured image I1 displayed on the display device 4 as the master image I2, they perform the registration operation using a touch panel 4a or a keyboard 3a. The master image registration unit 220 registers the captured image I1 for which the registration operation has been performed by the user as the master image I2, and outputs it to, for example, the storage device 26 to store it in the storage device 26.

The master image registration unit 220 has an inspection window setting unit 221. The inspection window setting unit 221 receives instructions regarding the position, range, shape, etc. of the inspection window for the captured image I1 registered as the master image I2, for example. Specifically, the inspection window setting unit 221 displays a GUI for setting the inspection window on the display device 4. When the user inputs the position, range, shape, etc. of the inspection window on the GUI using a touch panel 4a or a keyboard 3a, the inspection window setting unit 221 accepts the setting operation by the user and outputs it as information regarding the inspection window to, for example, the storage device 26, and stores it in the storage device 26. The inspection window setting unit 221 reflects the setting of the inspection range based on the positional relationship of the inspection window to the captured image I1.

The inspection condition setting unit 230 is a part that sets the output conditions for inspection results, that is, under what conditions the judgment results of each tool used for inspection will output a predetermined inspection result. The inspection condition setting unit 230 displays a GUI that allows the selection of tools used for inspection and the setting of output conditions on the display device 4. Although not shown, this GUI has an area where any tool can be selected from rule-based tools or learning tools. When the user selects a tool on the GUI using a touch panel 4a or a keyboard 3a, the inspection condition setting unit 230 accepts the selection operation by the user. Additionally, this GUI has an area where output conditions can be set. When the user sets the output conditions on the GUI using a touch panel 4a or a keyboard 3a, the inspection condition setting unit 230 accepts the output condition setting operation by the user. As output conditions, for example, conditions such as “how many detected objects are required for the inspection result to be output as ‘Good’” when the tool is the AI object detection tool T2 described later or “under what conditions must the string meet for the inspection result to be output as ‘Good’” when the judgment tool is the AI-OCR tool T3 can be cited.

The learning tool setting unit 305 includes a learning data setting unit 310 and a classifier update unit 315. The learning data setting unit 310 is a part that accepts settings for handling the captured image I1 as learning data D1 and reflects those settings. The settings for handling the captured image I1 as learning data D1 include the setting of label information. Specifically, the learning data setting unit 310 includes a learning image selection unit 310a, a learning data generation unit 310b, and a label information setting unit 310c.

The learning image selection unit 310a is a part that selects the captured image I1 to be treated as a learning image. The learning image selection unit 310a accepts image selection operations by users using a touch panel 4a or a keyboard 3a on the GUI and outputs the image data of the selected learning image, which is the learning image I3, to the learning data generation unit 310b. The image selected by the learning image selection unit 310a may be an image other than the captured image I1. Furthermore, it may be configured such that the learning image I3 is selected automatically without accepting selection operations from the user.

The label information setting unit 310c displays a GUI incorporating the learning image 13 selected by the learning image selection unit 310a on the display device 4, accepts designation operations related to the setting of label information, and sets the label information based on the information designated by the operation.

The learning data generation unit 310b generates learning data D1 based on learning image data and label information. The learning data generation unit 310b acquires learning image data from the learning image selection unit 310a, acquires label information from the label information setting unit 310c, and outputs the generated learning data D1 to the classifier update unit 315. In this way, the control unit 21 functions as the learning data generation unit 310b that generates learning data D1.

The information acquired by the learning data generation unit 310b for generating the learning data D1 varies depending on the type of learning tool that the learning data D1 is used for. As will be described in detail later, for example, when generating the learning data D1 for the learning of the AI-OCR tool T3, the learning data generation unit 310b acquires learning image data, and as label information, specified position information indicating the relative position of characters in the learning image, specified character type information indicating the character type of the character, and specified size information indicating the size of the character in the image.

The learning data setting unit 310 may change the selection method of learning images and the setting method of label information according to the type of learning tool that uses the learning data D1 reflecting the settings of the learning data setting unit 310.

When the learning tool T1 determines based on the feature trend of the entire image area included in the inspection window set by the inspection window setting unit 221, the entire image area corresponding to the inspection window among the selected learning image I3 is regarded as the image area to which a label is assigned. In other words, the setting of the position to which the label is assigned by the label information setting unit 310c is unnecessary. In this case, the label information setting unit 310c can set the label information by only accepting the specification of the label, thereby reducing the operational procedures related to the setting of the learning data D1. The specification of the label here corresponds to the specification of the class when the label is a class label indicating the class.

Furthermore, in the above case, when the judgment result of the tool is treated as the inspection result (for example, “Good” or “Defective”), it becomes easier for the user to grasp the features of the images that should be classified into the corresponding class. In this case, the learning image selection unit 310a may accept image selection operations while fixing the class of the class label to be assigned. When the learning image selection unit 310a accepts the selection operation of the learning image I3 while displaying a GUI that guides, for example, “Please select the image you want to classify as the first class ‘Good’” on the display device 4, the image area to which the label is assigned is determined by the inspection window, and the label information setting unit 310c can set the label information as if the specified image area has been designated as the first class “Good” without accepting an operation to specify the class. Since the label information can be set based on the fixed class, the operation procedure related to the setting of the learning data D1 is reduced.

The learning tool, which is an AI object detection tool T2 that detects the target object taught by the user from the image area included in the inspection window set by the inspection window setting unit 221, accepts the specification operation of the position on the image and the specification operation of the label to be assigned to that position by the label information setting unit 310c. The learning image I3 is an image that contains the target object to be detected, and includes an image area where the target object is present and a background area where the target object is absent. Since the image area where the target object is present and the background area where the target object is absent should be assigned different class labels, it is necessary to accept the specification of the position where the label will be assigned. The label information setting unit 310c outputs a combination of specified position information indicating the position and specified class information based on the class label assigned to that position as label information to the learning data generation unit 310b. In this way, the user assigns the class label of class “target object (foreground)” to a predetermined position on the image, but the operation to specify the class may be omitted. Since the AI object detection tool T2 is a learning tool for detecting the target object, it is estimated that the position specified by the user on the image is where class label of class “target object” should be assigned. The label information setting unit 310c may omit accepting operation to specify class by accepting specification of position on the image while displaying guidance such as “Please specify the position of the target object in the image.”

The learning tool that performs recognition of characters in the image area included in the inspection window set by the inspection window setting unit 211, namely, the AI-OCR tool T3, also accepts position specification on the image by the label information setting unit 310c, similar to the AI object detection tool T2. In the AI-OCR tool T3, in addition to detecting characters, it also identifies the character type of the detected characters, so the label information setting unit 310c accepts operations to specify the character type as label specifications. By accepting operations to specify the character type, the label information setting unit 310c specifies two classes: the class “any character” and the character type class, and the specified character type information includes the class label of the class “any character” and the class label of the character type class. The label information setting unit 310c outputs the combination of the specified position information and the specified character type information as label information to the learning data generation unit 310b.

The label information output by the label information setting unit 310c is not limited to specified position information and specified class information, and may include size information and angle information. The size information and angle information may be specified by size labels and angle labels separately provided by the user, but when the label information setting unit 310c allows the user to specify a position with a rectangular boundary box, the specified size information and specified angle information can be obtained from that boundary box. The specified size information and specified angle information may be used for updating the classifier.

The setting of learning data D1 for the AI-OCR tool T2 in this embodiment uses positioning information, specified size information, and specified character type information. As will be described in detail later, in this embodiment, the specified size information is incorporated into the specified character type information. In other words, the character type with the specified size information is treated as a single character type class. At this time, the position on the image is specified using a boundary box on the GUI, and the combination of the size corresponding to the boundary box and the specified character type class assigned to that position is used to identify the character type class corresponding to the specified position by the label information setting unit 310c. Therefore, the label information in the case of setting the learning data D1 for the AI-OCR tool T2 is a combination of the position in the captured image and the specified character type class for that position.

The classifier update unit 315 receives the learning data D1 generated by the learning data generation unit 310b and executes the update of the classifier based on the learning data D1 using a method that includes machine learning technique, and has a classification unit update part 315a and a class addition part 315b. In this embodiment, the classifier update unit 315 functions as a learning execution unit, and therefore the control unit 21 also functions as a learning execution unit that executes learning based on the learning data, controlling on-site learning to the pre-trained model.

Here, pre-training refers to the process in which the provider of the image inspection device S creates a model using machine learning techniques before providing the product to the user. Therefore, the pre-trained model refers to the model at the time of providing the image inspection device S by the provider. Furthermore, on-site learning refers to the process in which a user who has received the image inspection device S presents learning data and creates or modifies a model using techniques including machine learning.

The classifier update unit 315 updates the classifier used in inspection by implementing a predetermined update method based on the received learning data D1. In other words, the classifier update unit 315 performs learning using the learning data D1. The classifier to be updated varies depending on the selected learning tool. The classifier update unit 315 inputs the image data contained in the learning data D1 into the feature extraction unit 510 of the classifier to be updated and updates the classifier using a method that includes a machine learning technique utilizing the extracted features (feature vector or feature map) and the label information corresponding to the image data.

The classification unit update unit 315a updates the classification unit 520 of the determiner to be updated, which classifies image data into classes. Specifically, the classification unit update unit 315a executes the feature extraction unit 510 of the determiner to be updated, inputs the learning image data of the learning data D1, and obtains the feature F (feature vector). As a result, the learning data group is treated as a group of “combinations of feature vectors and class labels corresponding to each feature vector.” Based on this combination group, the boundary surface is generated so that each class specified by the class label is distinguished in the feature space where the feature vector of feature F is mapped. When additional learning data is present, the boundary surface is readjusted so that the additional feature F in the feature space is classified into the class associated with the additional feature F.

If the classifier updated by the classifier update unit 315 is a classifier executed by the learning tool T1, the classification unit update unit 315a executes the feature extraction unit 510 to obtain feature F1 from the entire learning image data included in the learning data D1. Then, the classification unit update unit 315a updates the image classification unit, which is a classifier 520 that classifies image data into classes set by the user. The image classification unit is an SVM (Support Vector Machine) as a linear classifier.

When the classifier updated by the classifier update unit 315 is a classifier executed by the AI object detection tool T2, similarly to when it is a classifier executed by the learning tool T1, the classification unit update unit 315a updates the image region classification unit. The image region classification unit is also a linear classifier, similar to the image classification unit. The point of difference compared to when the classifier update unit 315 updates a classifier executed by the learning tool T1 is that the feature extraction unit 510 inputs a part of the region image of the learning image data to obtain feature F2 (feature vector), and otherwise updates the classification unit in the same manner as in the case of the learning tool T1.

The Class Addition Unit 315b updates the target classifier to be able to classify into an additional class specified by the learning data D1, in addition to the existing classes that can be classified before the update. Typically, since the classification unit optimizes parameters in comparison with other classes, it is necessary to learn using at least one image data for each target class. The parameter update by the Classification Unit Update Unit 315a uses at least one image data for each target class. In on-site learning, there is a limit to the amount of image data collected, and if the parameters of the classification unit are updated only with image data that does not cover all classes, it may be possible to classify the class of the presented image, but the accuracy of classification for other classes and the classification accuracy of images that should belong to other classes may decrease. Furthermore, even if all classes can be covered, it is difficult to prepare an equivalent amount of image data for on-site learning as in pre-training, which leads to a decrease in classification accuracy for at least the existing classes. Additionally, learning by the Classification Unit Update Unit 315a tends to require a large amount of computation when there are many target classes, resulting in a high learning load. To reduce the learning load and increase the adaptability to the additional classes added in additional learning, the Class Addition Unit 315b updates the parameters by labeling the arrangement of extracted features obtained by the classification unit before the update. In this embodiment, when the Classifier Update Unit 315 updates the classifier of the AI-OCR Tool T3, the Class Addition Unit 315b updates the classifier.

The class addition unit 315b inputs a part of the area image of the learning image data into the feature extraction unit 510 to obtain the feature F3, which is similar to the case where the classifier of the AI object detection tool T2 is updated. The difference from the case where the AI object detection tool T2 is updated is that the classifier's judgment unit 520 is the character type output unit 523 obtained by the metric learning method in the pre-training. More specifically, the character type output unit 523 is pre-trained so that the distances between feature vectors of the same character type class are small and the distances between feature vectors of different character type classes are large in the embedding space. At this time, representative vectors are defined as representative feature vectors for each character type class, and the character type output unit 523 classifies the image data into the character type class of the representative vector that is close in distance to the feature vector of the image data and outputs the classification result. In the character type output unit 523, which has undergone such pre-training, the feature vector that should be classified into a new character type class based on the learning data D1 is arranged in the embedding space to be separated from the representative vector of the existing character type class when it is a different character type from the existing character type class. The class addition unit 315b utilizes this arrangement of feature vectors to define the feature F3 extracted from the learning data D1 as a new representative vector. That is, the calculation parameters up to the arrangement of the feature F (feature vector) in the embedding space remain the same, enabling classification into a new character type class. In addition, the class addition unit 315b adds a class that combines the specified size and specified character type among the label information of the learning data, that is, a new character type class “the character type including the specified size”.

The inspection execution unit 400 includes a rule judgment unit 402, a learning tool execution unit 403, and an inspection result output unit 410.

The rule judgment unit 402 is a part that makes a judgment based on the inspection tool when a rule-based tool is included in the inspection tools used for inspection, for the captured image I1 of the inspection target. The parameters set by the parameter setting unit 205 are used.

The learning tool execution unit 403 is a part that executes the classifier when the learning tool is included in the inspection tool used for inspection and outputs the judgment result for the captured image I1 of the inspection target. The classifier includes a feature extraction unit 510 and a judgment unit 520.

The feature extraction unit 510 is composed of, for example, a convolutional neural network. The feature extraction unit 510 is a part that extracts features indicating the characteristics of the input image data from the image data, and can also extract features for any position in the input image data. The feature extraction unit 510 is a part that is pre-trained to extract features corresponding to each learning tool and has parameters used in the process of extracting feature F from the image data.

The feature extraction unit 510 is capable of extracting feature F in a format corresponding to the learning tool. For example, when the learning tool T1 is executed, image data (captured image I1) is input to the feature extraction unit 510, and a multidimensional feature vector is obtained as feature F. Furthermore, when a judgment utilizing the spatial information of the input image is made, image data is input to the feature extraction unit 510, and a feature map is obtained in which a feature vector is calculated for each convolution pixel corresponding to a certain range of pixel areas in the input image data.

The judgment unit 520 is a part that outputs judgment results based on the input feature F (feature vector or feature map). The judgment unit 520 executed in the learning tool execution unit varies according to the learning tool, and at least one of the image classification unit, the image region classification unit, the character type output unit 523, the size output unit 524, and the image region angle output unit 525 is executed.

The image classification unit classifies the feature quantity F4 obtained from the feature extraction unit 510. The feature quantity F4 is a feature vector. The image classification unit outputs information indicating which class the image data corresponding to the feature quantity F4 belongs to. In the execution of the learning tool T1, the image classification unit is executed, and if the learning tool T1 is set to classify into the first class “good” and the second class “defective” by the learning tool setting unit 305, the image classification unit outputs information indicating whether the captured image I1 belongs to the first class or the second class based on the feature quantity F4 obtained from the captured image I1.

The image area classification unit classifies each convolution pixel of the feature map based on the feature quantity F5 obtained from the feature extraction unit 510. Since the image area classification unit classifies each convolution pixel of the feature map, it can output where in the captured image I1 the image area classified into the specified class exists, based on the spatial information possessed by the feature map. When the image area classification unit is executed in the execution of the AI object detection tool T2, the convolution pixels of the feature map F5 are classified as either the first class “object (foreground)” or the second class “background” by the image area classification unit. Therefore, based on this classification result, it can be determined where in the captured image I1 corresponding to the feature map F5 the area image belonging to the first class “foreground” exists, that is, whether the work W as the object exists.

The image area classification unit executed in the operation of the AI-OCR tool T3 classifies each convolution pixel of the feature map as feature quantity F6 into the first class “foreground” class and the second class “background”. Based on this classification result, it can be determined where the character image area is in the captured image I1 corresponding to the feature quantity F6.

The character type output unit 523 is executed in the execution of the AI-OCR tool T3. The character type output unit 523 outputs the classification result of the character type class based on the feature quantity F7 obtained from the feature extraction unit 510. Since the feature quantity F7 is a feature map, the character type output unit 523 can determine where in the captured image I1 corresponding to the feature quantity F7 there is a character image area belonging to any character type class. When classified into an additional character type class by the character type output unit 523, the classification result allows us to obtain as a determination result where in the image data corresponding to the input feature map, what type of character image exists, and what size it is.

The size output unit 524 is executed when the AI-OCR tool T3 is executed, and outputs the size of the corresponding image area based on the feature quantity F8 output from the feature extraction unit 510. The feature quantity F8 is a feature map. The size output unit 524 executed in the execution of the AI-OCR tool T3 outputs the size of the character image area corresponding to each pixel of the feature map.

The image region angle output unit 525 outputs information on the angle at which the corresponding image region exists based on the feature quantity F9 output from the feature extraction unit 510. The image region angle output unit 525, which is executed in the execution of the AI object detection tool T2, outputs angle information when the image region of the input data corresponding to each pixel of the feature map as the feature quantity F9 is the image region of the work W.

The inspection result output unit 410 generates and outputs inspection results based on the judgment results obtained from the execution of the judgment unit 520 according to the output conditions set by the inspection condition setting unit 230. For example, if the tool used for inspection is only the learning tool T1, and the output condition is set to take the judgment result of the learning tool T1 as the inspection result, the inspection result output unit 410 obtains the class classification results of the first class “Good” and the second class “Defective” as the judgment results for the image data of the captured image I1. Then, the inspection result output unit 410 generates an inspection result indicating that the captured image I1 is an image of a good product when the obtained judgment result is the first class “Good”, and outputs the inspection result from the I/O board 25 to the PLC or the like.

Inspection condition setting unit 230 sets an inspection using AI object detection tool T2, and if the output condition is that “work W is detected one or more times” and outputs “ON” as the inspection result, the inspection result output unit 410 obtains the classification result from the image area classification unit 521 as the judgment result, and displays as the judgment result where and at what angle work W exists in the image data corresponding to the input feature quantity F2. Then, the inspection result output unit 410 generates the inspection result based on the number of work W shown in the judgment result in the image data, displays the area corresponding to the detected work W on the target image data, and outputs the inspection result to PLC or the like. In this example, the number of work W to be detected is specified as the output condition, but parameters such as the number of work W may also be set as conditions for the judgment of AI object detection tool T2. Furthermore, if the angle of the image area is estimated in the judgment based on AI object detection tool T2, conditions using angles such as “the detected work W is within +15° of the master image's work W” may be set as output conditions.

The AI object detection tool T2 can register multiple types of target objects for object detection. For example, by registering the first target object, work W1, and the second target object, work W2, which has a different shape, color, and size from the first target object, the inspection result generation unit 332a obtains the judgment result of where work WI exists in the image data and at what angle, as well as the judgment result of where work W2 exists in the image data and at what angle.

Inspection condition setting unit 230 sets an inspection using AI-OCR tool T3, and when the output condition “the characters following ‘best before date’ indicate a date within three days from the inspection date” is set, the inspection result output unit 410 obtains a judgment result indicating where in the image and what character image exists. The inspection result output unit 410 generates the inspection result based on the character information indicated in the judgment result, displays the area corresponding to the detected character image on the target image data and the character type corresponding to that area, and outputs the inspection result to a PLC or the like. At this time, for the existing character type class, the inspection result output unit 410 obtains a judgment result indicating where in the image, what character image exists, and what size it is, based on the classification result by the character type output unit 523 and the size output unit 524, for the image data of the captured image I1 corresponding to the input feature quantity F. For the additional character type class, the inspection result output unit 410 obtains a judgment result indicating where in the image, what character image exists, and what size it is, based on the classification result by the character type output unit 523.

The inspection result output unit 410 may generate and output inspection results by combining multiple inspection tools, including rule-based tools and learning tools. For example, if the learning tool T1 determines the first class as “good,” and the AI object detection tool T2 determines that there are two target objects in the image, and the AI-OCR tool T3 determines that the expiration date is correctly printed on a predetermined part of the target object detected by the AI object detection tool T2, it can also output the inspection result “ON.”

The inspection result output unit 410 also has an additional learning image designation unit 415. Based on the judgment results obtained from the judgment unit 520 and the inspection results generated based on the judgment results, a GUI that accepts the designation of the learning image I3 to be added as a target for on-site learning can be displayed on the display device 4. The user can specify the learning image using the additional learning image designation unit 415. When an image is specified by the additional learning image designation unit 415, information related to the specified image is output to the learning data setting unit 310. The learning data setting unit 310 treats the image specified by the additional learning image designation unit 415 in the same manner as the learning image I3 selected by the learning image selection unit 310a. In other words, the learning data generation unit 310b generates learning data D1 based on the learning image data of the learning image I3 specified by the additional learning image designation unit 415 and the label information set by the label information setting unit 310c.

### (When Setting the Image Inspection Device)

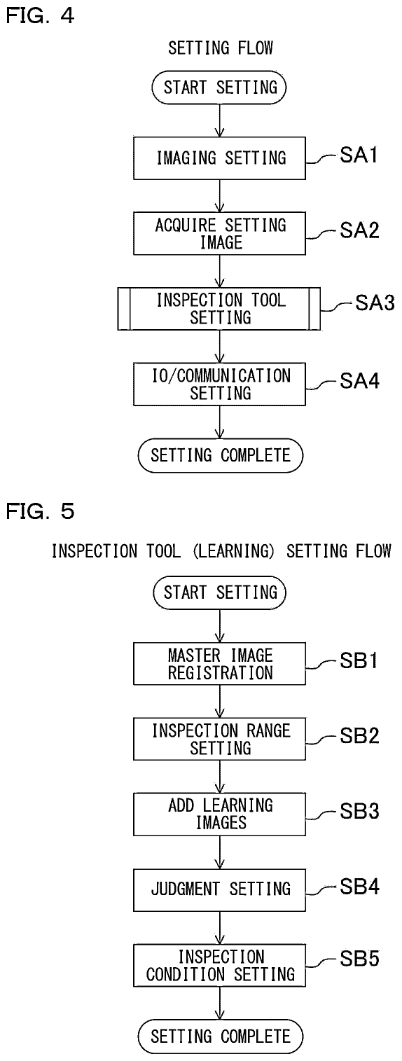

FIG. 4 is a flowchart showing the control of the control unit 21 during the setting of the image inspection device S. In step SA1 after the start, the control unit 21 receives the setting of imaging setting parameters from the user via the imaging setting unit 100 and sets the imaging setting parameters. In step SA2, the imaging setting parameters set in step SA1 are applied to execute imaging by the imaging unit 1. The image data acquired by the imaging unit 1 is stored in the storage unit 26 and treated as the master image I2 and the learning image I3.

In the inspection setting of step SA3, input related to the image inspection settings for the captured image I1 is accepted. In step SA4, input of signals from external sources, output of signals to external sources, and communication settings are performed.

FIG. 5 is a flowchart showing the details of step SA3 when using a learning tool as an inspection tool. In step SB1, the control unit 21 registers the image obtained in step SA2 shown in FIG. 4 as the master image I2 by the master image registration unit 220. In step SB2, the inspection window setting unit 221 sets the inspection range on the master image I2 registered in step SB1.

In step SB3, the control unit 21 selects the learning image I2 by the learning image selection unit 310a.

In step SB4, the control unit 21 sets the settings related to the judgment of the learning tool. More specifically, label information is set by the label information setting unit 310c, learning data D1 is generated based on the label information by the learning data generation unit 310b, and the classifier is updated based on the learning data D1 by the classifier update unit 315. For example, in the learning tool T1, when the user is asked to select image data belonging to a class in a state where the class is determined, the user's selection of image data is both the acceptance of the selection of the learning image I3 in step SB3 and the acceptance of input for the judgment setting in step SB4. Thus, depending on how the input from the user is accepted, steps SB3 and SB4 may be executed simultaneously.

In the case where the label assignment target is not specified in conjunction with the selection of the learning image I3, such as in the AI-OCR tool T3, after the learning image I3 is selected by the learning image selection unit 310a in step SB3, the label information setting unit 310c uses the selected learning image I3 to accept user designation related to step SB4. However, by using the classifier in the setting of step SB4, the acceptance of user designation can be omitted. For example, a class label may be assigned to the learning image selected in step SB3 using an existing classifier, and learning data is generated based on the assigned class label. In such a case, steps SB3 and SB4 may be performed simultaneously, similar to the aforementioned learning tool T1.

In step SB5, the inspection condition setting unit 230 sets the output conditions for generating inspection results based on the judgment results. For example, when using the AI object detection tool T2 as the inspection tool to count the work W, it sets how many areas judged as objects by the AI object detection tool T2 will output the inspection result as “ON”.

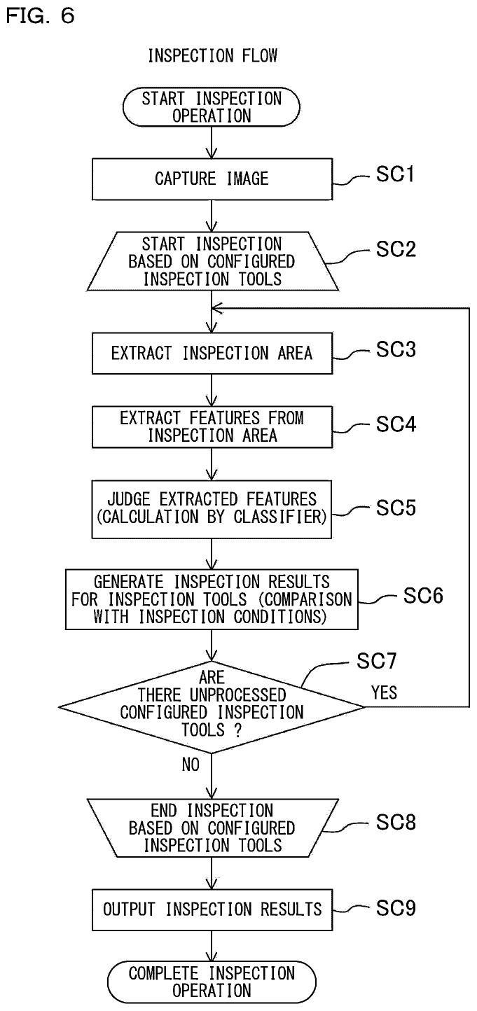

(During operation of the image inspection device) FIG. 6 is a flowchart showing the control procedure of the control unit 21 during inspection operation including the learning tool of the image inspection device S. The image inspection device S can switch between a setting mode for performing settings as shown in FIGS. 4 and 5, and an operation mode shown in FIG. 6, but this mode switching does not have to be clear, and for example, during operation in the operation mode, it is possible to temporarily switch to the setting mode to change settings and then return to the operation mode, allowing for continuous operation.

In step SC1 after the start, the imaging unit 1 captures the work W and acquires the captured image I1 of the work W. In step SC2, the inspection execution unit 400 starts inspection based on the configured learning tool for the image of the work W acquired in step SC1. First, in step SC3, based on the inspection range set by the inspection window setting unit 221, the range to be inspected is cut out from the image of the work W acquired in step SC1.

In step SC4, the feature quantity of the image data of the inspection area cut out in step SC3 is extracted by the feature extraction unit 510. In step SC5, the feature quantity extracted in step SC4 is judged by the judgment unit 520. As mentioned above, in steps SC4 and SC5, the feature quantity changes depending on the learning tool or the classifier being executed.

In step SC6, the judgment result is generated by the learning tool. If inspection conditions related to the judgment result are set in the learning tool, the judgment result is determined based on the comparison result with the corresponding inspection conditions. For example, if the condition “is within ±15° angle with respect to the work W in the master image” is set for the AI object detection tool T2, the judgment result is generated based on this condition. In step SC7, the presence or absence of unprocessed configured inspection tools is determined. If there are unprocessed configured inspection tools, the process proceeds to step SC3, while if there are no unprocessed configured inspection tools, the process proceeds to step SC8. In step SC8, the inspection based on the configured inspection tools is concluded.

In step SC9, the inspection result output unit 410 outputs the inspection result. If there is only one inspection tool included in the inspection, the judgment result related to that inspection tool is output as the inspection result as is. However, when combining the judgment results of multiple inspection tools, the inspection result is generated and output based on the judgment results of each inspection tool.

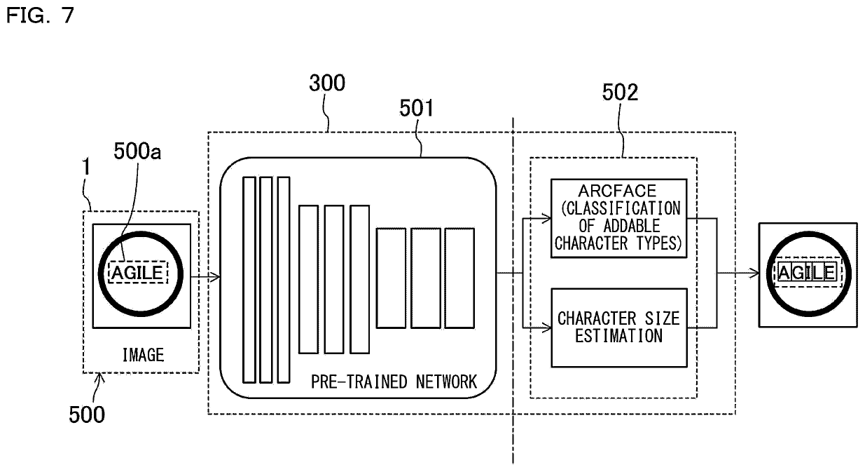

(AI-OCR Details) FIG. 7 is a diagram showing the concept of the feature extraction unit 510 and the judgment unit 520 related to the classification of character type classes when the learning tool execution unit 403 executes the AI-OCR tool T3. In the execution of the AI-OCR tool T3, the learning tool execution unit 403 executes the character type output unit 523 for the classification of character type classes. Furthermore, the learning tool execution unit 403 executes the character type feature extraction unit 510a as the feature extraction unit 510 that extracts feature quantity F7 for the output of the character type output unit 523. During the operation of the image inspection device S, when the image data of the captured image I1 containing characters is obtained by the imaging unit 1, the image data is input to the pre-trained feature extraction unit 510. The character type feature extraction unit 510a is a computational model with a network structure, which is a convolutional neural network trained by machine learning methods to extract feature quantity F7 suitable for the output of the character type output unit 523. The feature quantity F7 is input to the character type output unit 523 for the recognition of characters in the image area, which is a part of the input image data, and classifies the image area into the existing character type (first character type) class. At this time, the learning tool execution unit 403 controls the computation processing by the pre-trained character type output unit 523. Specifically, the learning tool execution unit 403 controls the classification task into the existing character type class by the pre-trained character type output unit 523. Since the position where the characters are printed is sometimes emphasized in image inspection, the image area 500a where the AI-OCR tool T3 is executed is set in advance, and the feature quantity F7 for that image area 500a may be input to the character type output unit 523.

The existing character type classes are multiple, and for example, character types such as alphabet, numbers, katakana, and hiragana are included in the existing character type classes. Characters may include symbols, and in this case, symbols are also included in the existing character type classes. The storage device 26 stores representative feature quantities of character type classes that represent feature quantities of character images belonging to the existing character type classes. The representative feature quantities of character type classes stored in the storage device 26 are accessible when performing character recognition processing.

The character type output unit 523 is a linear classifier that reads out the representative feature quantity of the character type class representing the character type class feature quantity of character images belonging to the existing character type class from the storage device 26. Based on the character type class feature quantity extracted from one character image area at any position in the input image data and the representative feature quantity of the character type class, it can output a value indicating the character type of the image area corresponding to the character type class feature quantity. Thus, for example, when the character type output unit 523 determines that the character type class feature quantity belongs to a specified character type class corresponding to a combination of character type and specified size, it can output the size of the character image in the image area based on the specified size included in the specified character type class. Note that when a character image combining multiple characters is registered as one character type class, the feature quantity F7 input to the character type output unit 523 is treated as a feature quantity corresponding to one character image area.

In this embodiment, the size of the character image area is estimated by executing the

AI-OCR tool T3, and character recognition results corresponding to the size are output. Therefore, the learning tool execution unit 403 executes a size output unit 524 that outputs the size of the image area as the judgment unit 520, and a size feature quantity extraction unit 510c that extracts feature quantity F8 suitable for the output of the size output unit 524. The size feature quantity extraction unit 510c is a convolutional neural network that has been pre-trained to extract feature quantity F8 suitable for the output of the size output unit 524, and feature quantity F8 is a feature map. The size output unit 524 estimates and outputs where and what size of image area exists in the captured image I1 based on feature quantity F8. In the AI-OCR tool T3, the character recognition result is output by combining the output from the character type output unit 523 and the output from the size output unit 524. According to this, the character recognition accuracy is improved. For example, in the example of FIG. 7, the width of the character image area occupied by “I” is smaller compared to the width of the character image areas occupied by other characters. If there is no part that outputs the size of the character image area, the size of the character image area is fixed, and character recognition is performed. If the size is fixed in the area of character images other than “I”, adjacent other characters will enter the character image area of “I”, resulting in a decrease in character recognition accuracy. By outputting the size of the character image area by the size output unit 524, the character type output unit 523 can output character types assuming various sizes of image areas, thereby improving character recognition accuracy.

In the example shown in FIG. 7, the learning of the feature extraction unit 510 is executed by the provider of the image inspection device S, and the configuration does not allow for on-site learning by the user. Regarding the character type output unit 523, the user is enabled to perform on-site learning. That is, the parameters of the feature extraction unit 510, which includes computationally intensive convolution operations, are fixed, and only additional learning of the character type output unit 523 is possible, allowing for additional learning by the CPU mounted in the control unit 21 without the need for a high-performance processing device such as a GPU. Furthermore, the size output unit 524 is also a part obtained by machine learning methods provided by the provider of the image inspection device S, that is, a part provided by pre-training, but since computationally intensive processing is required for further learning, the configuration does not allow for on-site learning.

Moreover, during inference, the inference by the feature extraction unit 510 is processed by, for example, the accelerator 21c specialized for convolution operations, and the inference by the judgment unit 520, such as the character type output unit 523, can be processed by, for example, DSP 21a or accelerator 21c.

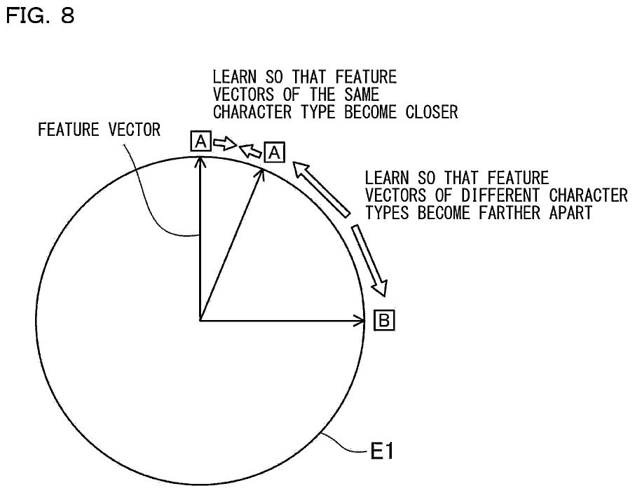

The concept of pre-training of the character type output unit 523 will be explained based on FIG. 8. This is also referred to as distance learning. The circle E1 in FIG. 8 schematically represents the feature space, which is actually a multidimensional space. For example, when learning the character types “A” and “B”, the same character type is learned so that the feature vectors approach each other, while the feature vectors of different character types are learned to move away from each other.

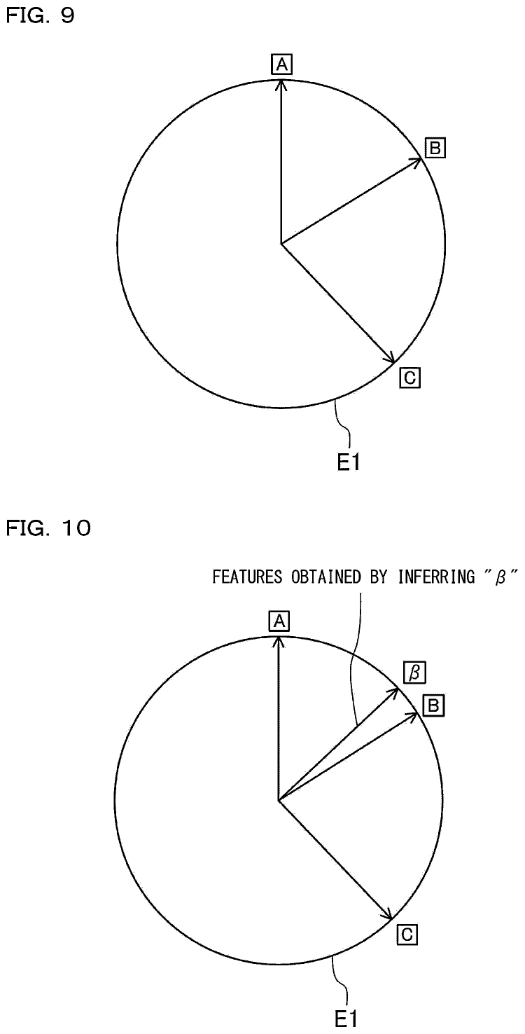

FIG. 9 shows the state of the character type output unit 523 when the image inspection device S is provided from the business operator to the user, that is, the state in which pre-learning of character types “A”, “B”, and “C” has been completed. As shown in this figure, basic alphanumeric characters have been pre-learned to be classifiable, and the representative vector, which is a representative feature vector, has been registered.

After the image inspection device S is provided to the user from the manufacturer, as shown in FIG. 10, when the character “B” is read by the image inspection device S, it is read as “B.” To explain in more detail, first, since “β” and “B” have different forms, the feature vector extracted from the character image of “β” is positioned away from the representative vector of the character type class “B.” However, since the representative vector located in the vicinity of the feature vector of “β” is the representative vector of the character type class “B,” the feature vector of the character image “β” is classified into the character type class “B.”

When the character image “β” is read as “B”, the user may want the character image “β” to be read as “β”. In other words, since the character image “β” is similar in form to the already registered “B” in the existing character type class, it is read as “B” as shown in FIG. 10, and such a reading result is output by the inspection result output unit 410. The user, after confirming the inspection result, specifies the character image “β” as the learning image I3 in the additional learning image designation unit 415 and instructs the on-site learning of the character type output unit 523.

Specifically, the learning data generation unit 310b generates learning data D1 that includes image area data containing “β” and specified character type information that specifies the character type indicated by the image area data containing “β”. In this case, since the character type is “B”, the specified character type information is information that specifies “β”.

The class addition unit 315b of the judgment unit update section 315 adjusts the parameters of the character type output unit 523 to classify the image area of the learning image data possessed by the learning data D1 generated by the learning data generation unit 310b into the class “β”, which corresponds to the specified character type, that is, an additional character type class different from the existing character type class. More specifically, the representative vector of “β” is added to the representative vectors read during the execution of the character type output unit 523, and the character type output unit 523 is adjusted to classify the image area corresponding to the feature vector determined to be close to the representative vector of “β” included in the feature F7 as character type “β”. At this time, the class addition unit 315b registers the representative vector of “β” based on the arrangement of the feature vector of “β” so that the feature F3 extracted from the character image “β”, that is, the feature vector of “β” arranged in the feature space by the character type output unit 523 before the update, is not classified into the existing character type class “B”. At this time, since the feature vector of “B” is also registered, when a character image closer to “B” than “β” is input, the feature F7 extracted from the character image is maintained in a position closer to the representative vector “B”, resulting in being read as “B”.

In this way, it is not necessary to adjust the arrangement of predetermined feature quantities in a multidimensional space, and it is sufficient to store the feature vector based on the feature vector of the image data specified additionally. Therefore, retraining equivalent to pre-training is not required, and the image inspection device S can perform on-site learning so that new character type class classification can be possible on the user side without deteriorating the reading performance at the time the device is provided from the business operator to the user. Furthermore, the learning image for on-site learning may be just one image.

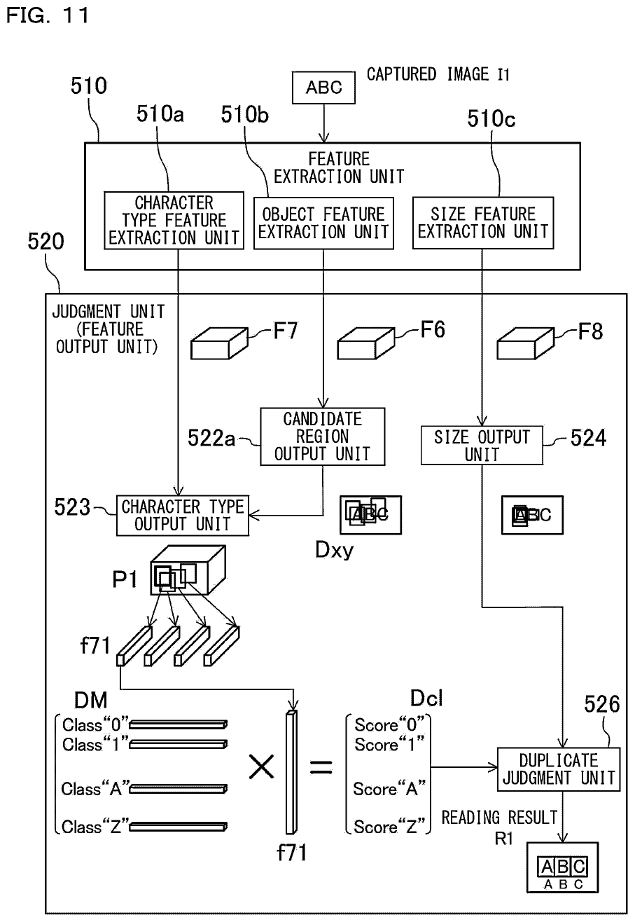

(Example of Character Recognition) FIG. 11 specifically illustrates the flow of character recognition processing. First, during the operation of the image inspection device S, the image data of the captured image I1 obtained by the imaging unit 1 is input to the feature extraction unit 510. The feature extraction unit 510 is a pre-trained part that has been pre-learned to extract features according to the application. The feature extraction unit 510 includes a character type feature extraction unit 510a, an object feature extraction unit 510b, and a size feature extraction unit 510c. The object feature extraction unit 510b extracts a feature F6 that indicates the object-like quality of the image area, that is, whether the image area is foreground or background. In addition, the size feature extraction unit 510c extracts a feature F8 related to the size of the image area. In this embodiment, for convenience, each feature extraction unit is described as a separate part, but it may also be configured such that each feature extraction unit extracts individual features from the features extracted by a common model structure. Furthermore, it may also be configured such that the same features are extracted for different applications.

The three features extracted by the feature extraction unit 510 are sent to the judgment unit 520 as the feature output unit.

The feature quantity F6 extracted from the target object feature extraction unit 510b is a feature map and is sent to the candidate region output unit 522a as an image region classification unit. The candidate region output unit 522a calculates the probability value that the image region corresponding to each convolution pixel is the target object based on the feature quantity F6. The probability value is calculated by known methods, such as calculating the similarity with the feature quantity indicating the image region of the target object. Then, the candidate region output unit 522a designates the image region where the probability value is above the threshold as a candidate region and outputs the candidate region information Dx,y indicating the position of the candidate region in the captured image I1. Note that the candidate region information does not include information related to the size of the candidate region. In this embodiment, in order to detect all character image regions that may be detected separately as adjacent character image regions or multiple character image regions in the captured image I1, the candidate region information Dx,y is output without considering the spatial information in the captured image I1. However, it may also be configured to generate a heat map in which the character likelihood is arranged according to the spatial information of the captured image I1 and to output the candidate region information based on the peak position in the heat map. With this configuration, it is possible to reduce overlapping candidate regions for the same character image region, thereby reducing the computational cost of processing using candidate region information. When outputting candidate region information Dx,y without considering spatial information in captured images 11, for example, it can prevent omission of output for correct character regions near peak positions that differ from peak positions, thus improving OCR accuracy.

The feature quantity F7 extracted by the character type feature quantity extraction unit 510a is sent to the character type output unit 523. The feature quantity F7 is a feature map, and this feature map has H dimensions (height) and C dimensions (feature quantity). The character type output unit 523 outputs a value indicating the character type of the corresponding image area based on the feature quantity corresponding to the image area indicated by the candidate region information Dxy. More specifically, based on the candidate region information Dxy, the feature quantity f71 corresponding to the first candidate region P1 is identified from the feature quantity F7, and the character type is output based on the feature quantity f71. Here, the character type feature quantity may be normalized to a length of 1. It is also possible that the feature quantities F6 and F7 are common feature quantities, which reduces the processing of the feature quantity extraction unit 510. In this embodiment, the configuration identifies the feature quantity f71 from the feature quantity F7, but it may also be a configuration in which only the feature quantities of the candidate regions are extracted from the feature quantity extraction unit 510 based on the candidate region information Dxy. Furthermore, in this embodiment, the character type output unit 523 identifies the feature quantity f71 based on the candidate region information Dxy to speed up the processing of the character type output unit 523, but it may also be a configuration that outputs the character type for all or part of the convolution pixels of the feature quantity F7 as a feature map.

The character type output unit 523 infers which character type class the candidate region P1 corresponding to the feature quantity f71 belongs to by calculating the product of the dictionary matrix DM, as shown in FIG. 11, and the feature quantity f71 as a feature vector. The dictionary matrix DM contains representative vectors for each character type class corresponding to the number of registered characters (the number of character type classes). The character type output unit 523 outputs the probability values that the candidate region P1 belongs to each character type class as scores by calculating the product of the feature quantity f71 and the dictionary matrix DM. In this way, the character type output unit 523 calculates scores for each character type class for each candidate region specified by the candidate region information Dxy. Therefore, the information output by the character type output unit 523 is a combination of the candidate region information Dxy and the character type information Dcl related to the character types of each candidate region. The character type information Dcl is composed of scores related to all character type classes indicated by the dictionary matrix DM, but it may also be information regarding only some character type classes, such as those with high scores, or information that does not include scores.

The feature quantity F8 extracted by the size feature quantity extraction unit 510c is sent to the size output unit 524. The size output unit 524, as the judgment unit 520, outputs size information Dhw related to the size (width, height) of the image area based on the feature quantity F8. Since the feature quantity F8 is a feature map, the size output unit 320f can output the size information Dhw of the character image of each image area based on the feature quantities of each convolution pixel constituting the feature quantity F8, and outputs a combination of the position of the image area contained in the captured image I1 and the size information Dhw of the image area. For example, when the image area is determined not to belong to the specified character type class corresponding to the combination of the character type and the specified size described later, based on the feature quantity F7 extracted by the character type feature quantity extraction unit 510a, the character type output unit 523 is configured to output the size information Dhw of the image area, namely the character image area. Note that the feature map as the feature quantity F8 is extracted without considering whether it is a character image area or not, so the convolution pixels that are not character image areas contain values themselves. In this embodiment, the size information is expressed in terms of width and height, but it may also be expressed in terms of the subpixel position relative to the pixel that specifies the position of the image area.

The duplicate judgment unit 526 acquires the candidate region information Dxy output by the character type output unit 320b and the character type information Dcl, as well as the size information Dhw for each image area, and determines the duplication of the candidate region based on the character type class and size when the candidate region is a character image area.

The character type class of the candidate region is not considered in the process of outputting candidate region information Dxy from the captured image I1. Therefore, there is a possibility that multiple candidate regions are output from the same character image area. For this reason, when multiple adjacent candidate regions are determined to be of the same character type class, it is preferable to determine one of the candidate regions as a duplicate candidate region and delete it. However, when the candidate regions are correctly determined from the adjacent captured image I1 of the same character type, multiple adjacent candidate regions are also determined to be of the same character type class, so it is preferable to consider the spatial overlap of each candidate region in the captured image I1. Therefore, the duplicate determination unit 526 deletes duplicate candidate regions based on candidate region information Dxy, character type information Dcl, and size information Dhw. As will be described in detail later, when the image area is determined to belong to a specified character type class corresponding to a combination of character type and specified size based on feature F7, the size of the candidate region in the captured image I1 is specified by candidate region information Dxy and character type information Dcl, so the spatial overlap in the captured image I1 does not necessarily have to be determined based on size information Dhw. As a specific processing method, known methods such as Non-Maximum Suppression can be used. The duplicate determination unit 526 deletes candidate regions according to the determination result and outputs the character reading result R1 of the captured image I1 based on the remaining candidate regions.

By going through the flow of the above processing, the judgment unit 520 as the feature output unit outputs the reading result, and the user can obtain a reading result that includes a reading result display in which a rectangular GUI based on the output result from the size output unit 320f is superimposed, and character type information based on the output result from the character type output unit 320b is displayed adjacent to the rectangular GUI.

In this embodiment, overlapping candidate regions are deleted based on candidate region information Dxy, character type information Dcl, and size information Dhw. However, candidate regions may also be deleted based on either candidate region information Dxy and character type information Dcl, or solely on candidate region information Dxy. In this case, as mentioned above, there is a risk that the accuracy of duplicate determination may decrease, but the computational processing (in this embodiment, processing by character type output unit 523) that increases with the number of candidate regions can be reduced. The same applies when duplicate determination is based on candidate region information Dxy and size information Dhw.

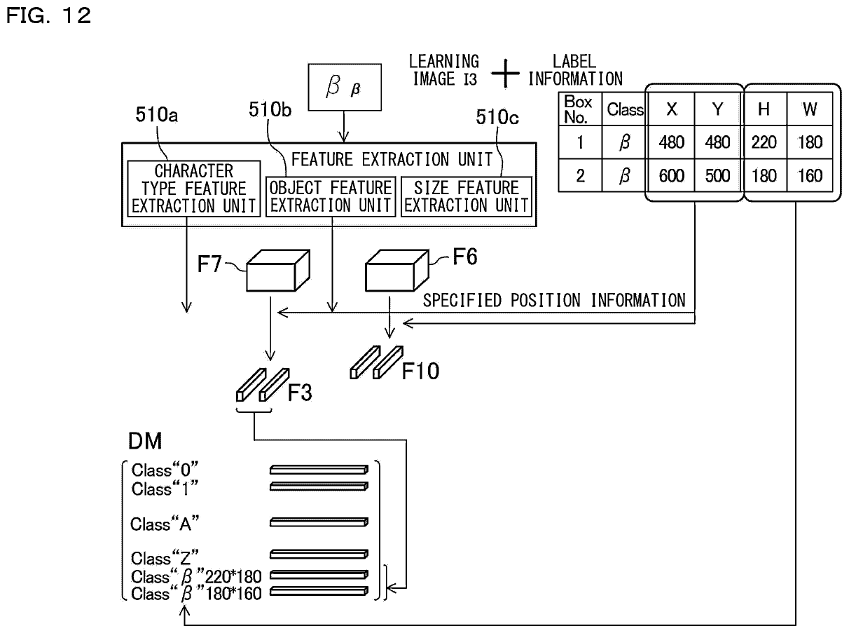

(Details of Dictionary Registration) FIG. 12 is a diagram showing a specific example of the dictionary registration process. The dictionary registration process is on-site learning of the AI-OCR tool T3, which includes updating the character type output unit 523 by the class addition unit 315b. For example, the case where a user registers the character “B” in the dictionary will be explained. The image data of the captured image I1, which includes the character “B”, is acquired by the imaging unit 1, and the user selects the captured image I1 as the learning image I3 using the learning image selection unit 310a.

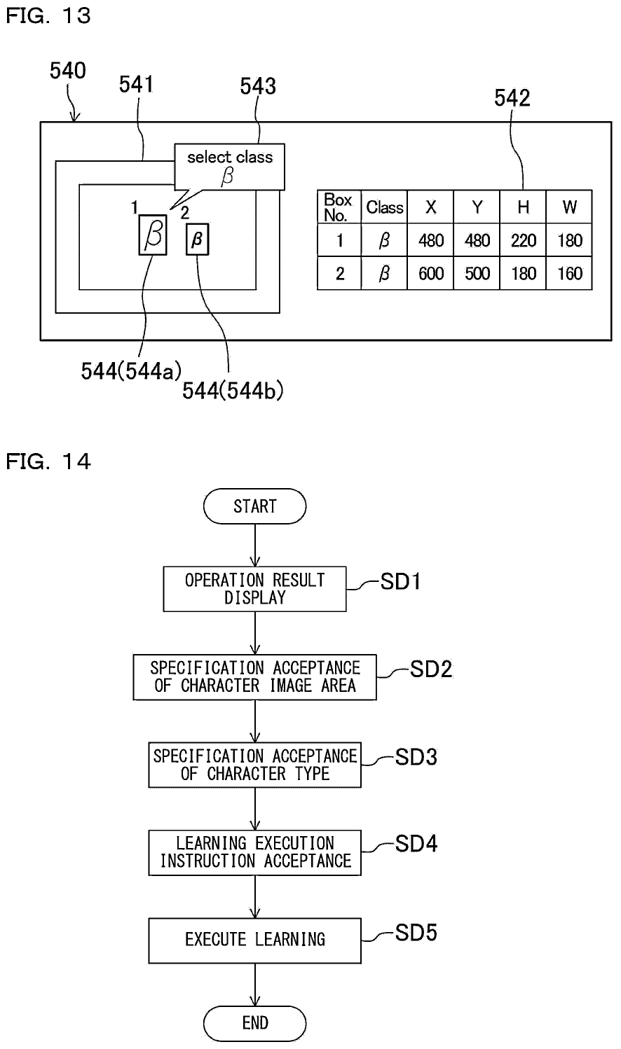

FIG. 13 is a diagram showing the GUI 540 generated by the learning data setting unit 310. The user sets label information for the learning image I3 using the label information setting unit 310c. When registering in the dictionary, the label information setting unit 310c generates a specification reception GUI 540 for accepting the user's specification of character position, character size, and label, and displays it on the display device 4. This specification reception GUI 540 has a target image display area 541 that displays the learning image I3 and a label information display area 542 that displays the label information set for the learning image I3. In the target image display area 541, a rectangular box 544 whose shape changes according to the user's operation is superimposed. In the label information display area 542, the specified character type, specified position, and specified size are displayed for each box 544. When the user sets label information for the learning image I3 using the label information setting unit 310c, the user first operates the position and size of the box 544 to correspond to the character image area of the learning image I3 displayed in the target image display area 541. When the user operates the box 544, the values of the specified position and specified size in the label information display area 542 change according to the operation content. The label information display area 542 also functions as an area that accepts user input, and the user performs input operations for the character type corresponding to the character area in the specified character type of the label information display area 542. When a character type is input into the label information display area 542, the input character type is displayed in the character type input region 543 near to the corresponding box 544 in the target image display area 541. The user can add or delete boxes 544 according to the number of character areas on the image 500, and the label information display area 542 is provided with a display area corresponding to the number of boxes 544. In addition, the area where the specified position and the specified size are displayed in the label information display area 542 also functions as an input area. As the specified position, the x-coordinate and y-coordinate for specifying the position of the character can be input, and as the specified size, the width and height for specifying the character size can be input. Furthermore, the character type input operation may be performed on the character type input region 543 superimposed on the target image display area 541.

In the example of FIG. 13, the GUI 540 for the case where the user adds two “β” with different fonts for on-site learning is shown. The two “β” in the learning image I3 look different because the fonts are different. The user places two boxes 544 for the two character image areas “β” and specifies the position and size of the corresponding character image area “β”. For convenience, the box 544 assigned the number 1 in FIG. 13 is referred to as box 544a, and the box 544 assigned the number 2 is referred to as box 544b. In the label information display area 542, the position and size of the corresponding character image areas are displayed according to boxes 544a and 544b, and as shown in the label information display area 542, the two “β” also differ in size. These two character image areas have the same character type “β”, but when the two character image areas are additionally subjected to on-site learning, the dictionary matrix DM will include feature vectors representing the “β” specified by box 544a in GUI 540 and the feature vectors representing the “β” specified by box 544b as separate classes. In this way, the learning data generation unit 310b generates learning data D1 that has specified size information indicating the size of the character image area in the image data of the learning image I3. The generated learning data D1 is input to the classifier update unit 315. In the classifier update unit 315, as the feature extraction unit 510, the character type feature extraction unit 510a is executed to extract feature F7 from the learning image I3, and the object feature extraction unit 510b is executed to extract feature F6 from the learning image I3.

Returning to FIG. 12, the details of the processing by the classifier update unit 315 will be explained. The class addition unit 315b as the classifier update unit 315 executes the character type feature extraction unit 510a to extract the feature F7 and identifies the feature F3 corresponding to the character image area specified by the user based on the specified position information (the x-coordinate and y-coordinate specified by the user) included in the learning data D1. In this embodiment, the learning image I3 included in the learning data D1 specifies two character image areas by boxes 544a and 544b, so two feature vectors are identified, and the class addition unit 315b adds the identified two feature vectors directly to the dictionary matrix DM. The boxes 544a and 544b are character image areas of the same character type, but are registered as feature vectors corresponding to different classes. In this embodiment, the identified features are added directly to the dictionary matrix DM, but it is also acceptable for features that can be sufficiently distinguished from existing representative features to be selected and added to the dictionary matrix DM based on the features.

The classification unit update part 315a as the classifier update unit 315 executes the object feature quantity extraction unit 510b to extract feature quantity F6 as a feature map, and extracts feature quantity F10 corresponding to the image area specified by the user based on the specified position information included in the learning data D1. The image area specified by the specified position information is the image area designated by the user as the character image area, so feature quantity F10 corresponds to the image area treated as a foreground area rather than a background. Therefore, the score, which is the probability value that the image area corresponding to feature quantity F10 is the object area, is updated in the candidate region output unit 522a so that it becomes higher than the score when the candidate region output unit 522a determines the candidate region. The method of updating the candidate region output unit 522a is not particularly limited, and for example, if a configuration is introduced that incorporates learning by SVM or evaluation by cosine similarity in the updated foreground output unit 320c, it can be learned by known methods.

While the learning tool execution unit 403 executes the size feature extraction unit 510c, the classifier update unit 315 does not execute the size feature extraction unit 510c in the dictionary registration process. Generally, a model that infers the size of a predetermined image area included in the input image data becomes computationally intensive when attempting to update it using machine learning methods. That is, when trying to update the size output unit 524 using machine learning methods so that size information Dhw based on specified size information is output for the image area of the learning data D1, the learning load becomes so large that it is difficult as on-site learning. Therefore, in the on-site learning of this embodiment, the update of the size output unit 524 is not performed, and thus, the size feature extraction unit 510c is not executed.

Therefore, in the on-site learning of this embodiment, the specified size information of the learning data D1, that is, the width and height specified by the user via the specification acceptance GUI 540, is reflected in the dictionary matrix DM and applied during inference after the dictionary registration process. More specifically, the additional character type class feature quantity is registered in the dictionary matrix DM as a feature corresponding to the combination of the character type and the size of the image area. The character image “β” specified in box 544a and the character image “β” specified in box 544b have the same character type “β” but different sizes, so the feature vector identified by box 544a corresponds to the combination of character type “β” and the size specified by box 544a, and the feature vector identified by box 544b corresponds to the combination of character type “β” and the size specified by box 544b, and is registered in the dictionary matrix DM. When the learning tool execution unit 403 executes the character type output unit 523, if the feature quantity f71 is determined to belong to the additional character type class, the candidate region P1 is determined to be an image area having the character image of the character type specified by the learning data D1 and the size specified by the learning data D1. In the example of FIG. 12, two character type classes with the character type “β” are added, and if the candidate region P1 is determined to belong to either of the two added character type classes, then it is determined that candidate region P1 has a character type of “β”, and its size reflects that of box 544 used for identifying features.

The update of the character type output unit 523 by the class addition unit 315b is performed not only to add character types other than those that can be classified by pre-training, but also when adding character image areas that were not read from existing character types. If there is an imaging image I1 for which reading has failed in the inspection results output by the inspection execution unit 400, the imaging image I1 is used as a learning image I3, and by performing on-site learning, the accuracy of the character type output unit 523 is improved.

At this time, as a representative example of the captured image I1 that fails to read, there is a captured image I1 that includes a blurred character image area. In this case, if the learning tool execution unit 403 executes the candidate region output unit 522a separately from the character type output unit 523 during the execution of the AI-OCR tool T3, it can reduce the decrease in reading accuracy due to on-site learning. More specifically, the blurred character image area may be close to the feature quantity of the background image area. In this case, if the feature vector corresponding to the blurred character image area is added to the dictionary matrix DM, the character type output unit may classify the background image area into the class corresponding to the blurred character image area, leading to a risk of misdetection. In this embodiment, the candidate region output unit 522a is executed separately from the character type output unit 523, and based on the output from the candidate region output unit 522a, the processing of the character type output unit 523 is executed, thereby reducing the risk of misdetection.

(Relearning after Operation) The image inspection device S is a device capable of executing a pre-trained character recognition model, as mentioned above. After the operation of the image inspection device S (also referred to as after operation), there may be misreading by the character recognition model; however, the image inspection device S of this embodiment extracts an image area, which is a part of the image in the input image data, when classifying a certain character, allowing user instruction regarding the misreading result to be possible using that image area. Furthermore, the image inspection device S can accept user instruction regarding the misreading result, and by accepting user instruction regarding the misreading result, it becomes possible to execute a model that requires a small amount of computation for learning based on user instruction. Additionally, since the image area is extracted, the user can provide instruction without setting the image area.

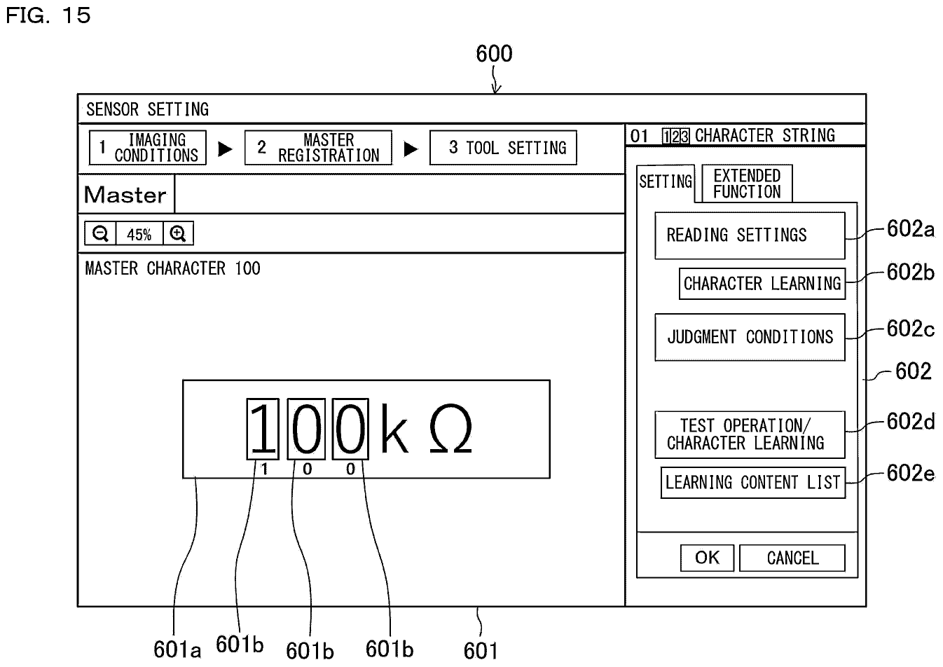

After the operation of the image inspection device S, the process for enabling the re-learning of the pre-trained model will be explained based on the flowchart shown in FIG. 14. This flowchart starts after the specification of the learning image is made by the additional learning image designation unit 415. In step SD1, the control unit 21 acquires the operation result of the image inspection device S and displays it on the display device 4. This step can be referred to as the operation result display step or the step of presenting the operation result to the user. FIG. 15 shows an example of a GUI for displaying the operation result, which is the operation result display screen 600. The operation result display screen 600 can be generated by the control unit 21 and displayed on the display device 4.

The operation result display screen 600 is provided with an operation result display area 601 and an operation reception area 602. The operation reception area 602 is equipped with a reading setting button 602a for setting the reading, a character learning button 602b for starting character learning, a judgment condition button 602c for setting judgment conditions, a button 602d for performing test operation/character learning, and a learning content list button 602e for displaying a list of learning contents. Each button 602a, 602b, 602c, 602d, and 602e is composed of an image displayed on the display device 4, allowing touch operations using the touch panel 4a; however, it may also be composed of physically operating buttons. The same applies to the buttons below.

The operation result display area 601 displays the image input to the model. In this example, “100 kΩ” is the string that the model wants to read. In the operation result display area 601, a first box 601a that surrounds the image area containing the string to be read and a second box 601b that surrounds the area of the characters read by the model are superimposed, and the reading results from the model, “1”, “0”, and “0” are also superimposed. The operation result display screen 600 allows the user to grasp the reading results.

In the example shown in FIG. 15, “k” and “Ω” are misread. “k” is a character that is pre-registered in the image inspection device S, but it is a character that has been misread. “Ω” is a character that is not pre-registered in the image inspection device S, and therefore it is a character that has been misread. In other words, “k” and “Ω” are both misread characters, but they differ in whether they are characters pre-registered in the image inspection device S or not.

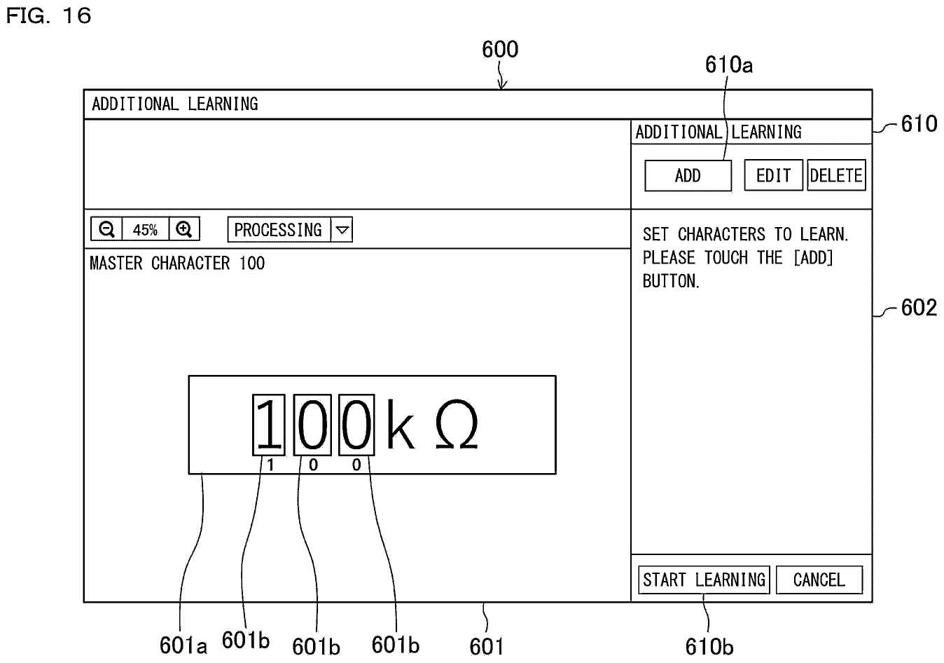

After the operation result display step of step SD1 in FIG. 14, proceed to step SD2, where the control unit 21 accepts the designation of the character image area by the user. Specifically, when the user operates the character learning button 602b shown in FIG. 15, the control unit 21 displays the additional learning window 610 shown in FIG. 16 in the operation reception area 602 of the operation result display screen 600. The additional learning window 610 is provided with an add button 610a for adding characters to be learned and a learning start button 610b for starting the learning.

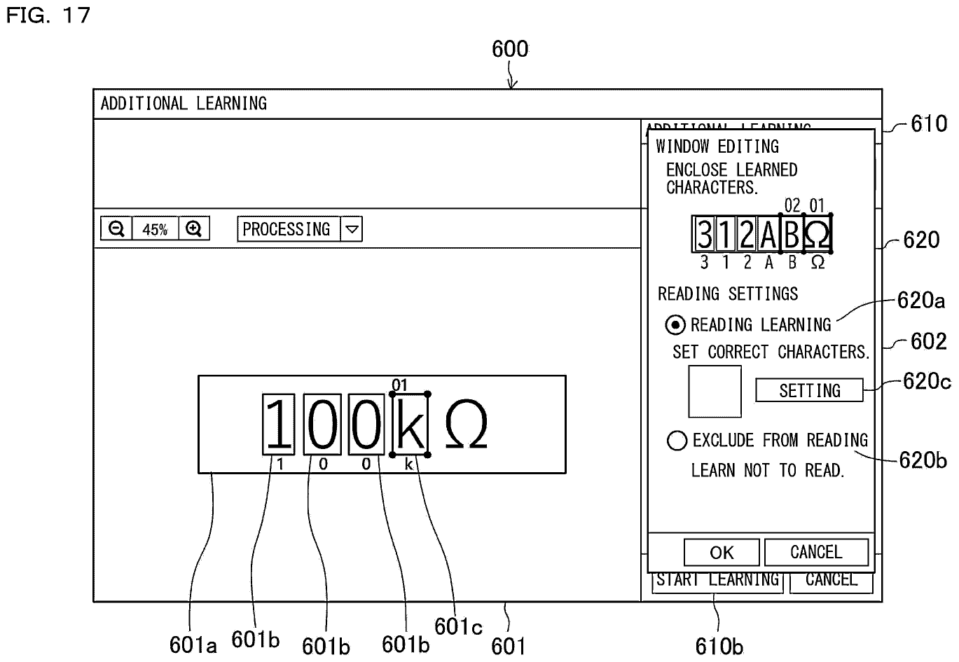

When the user operates the add button 610a, the control unit 21 displays the additional learning window 620 shown in FIG. 17 in the operation reception area 602 of the operation result display screen 600. In the additional learning window 620, reading settings are enabled. This example shows the case of adding the character “k” for additional learning, and when performing the reading settings, first, the user forms a third box 601c that surrounds the character “k” to be learned on the image displayed in the operation result display area 601. The third box 601c can be formed by touch operations by the user, for example, by dragging from the upper left to the lower right of the character to be learned to form the third box 601c. Once the third box 601c is formed, the control unit 21 identifies the character image area surrounded by the third box 601c and accepts the designation of the character image area.

Then, the process proceeds to step SD3 shown in FIG. 14, where the control unit 21 accepts the specification of the character type of the characters included in the character image area received in step SD2. The additional learning window 620 shown in FIG. 17 allows for the setting of whether or not the characters enclosed in the third box 601c are to be the learning target. Specifically, the additional learning window 620 is provided with a character setting area 620a for setting the characters enclosed in the third box 601c as the correct characters, and a reading exclusion setting area 620b for setting the characters enclosed in the third box 601c as characters excluded from reading.

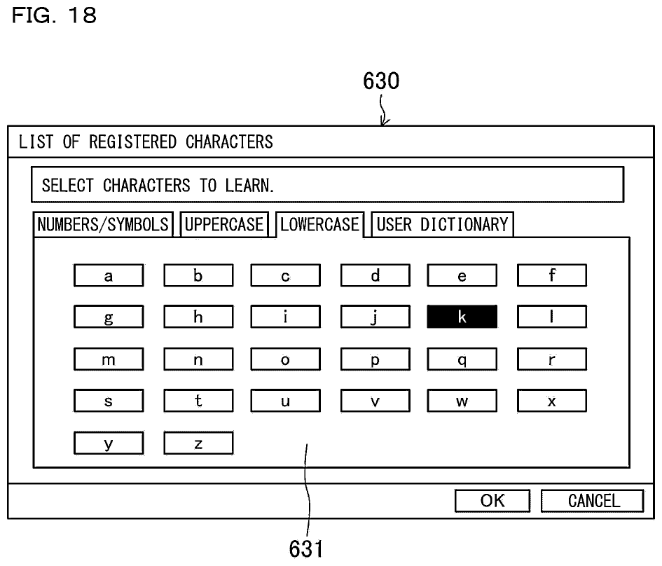

When the setting button 620c of the character setting area 620a is operated, the control unit 21 generates the character type selection window 630 shown in FIG. 18 and displays it on the display device 4. The character type selection window 630 is provided with a character type display area 631 in which the character types (registered character types) that are pre-registered in the image inspection device S are listed. The character type display area 631 displays multiple tabs, allowing the user to select any tab. The multiple tabs include, for example, a tab classified for numbers/symbols, a tab classified for uppercase alphabet letters, a tab classified for lowercase alphabet letters, and a user dictionary tab that classifies characters registered by the user. When the user performs an operation to select the desired tab, the character types classified under the selected tab are listed in the character type display area 631. The character types displayed in the character type display area 631 can each be selected by the user, and the example shown in FIG. 18 illustrates the case where the user selects ‘k’.

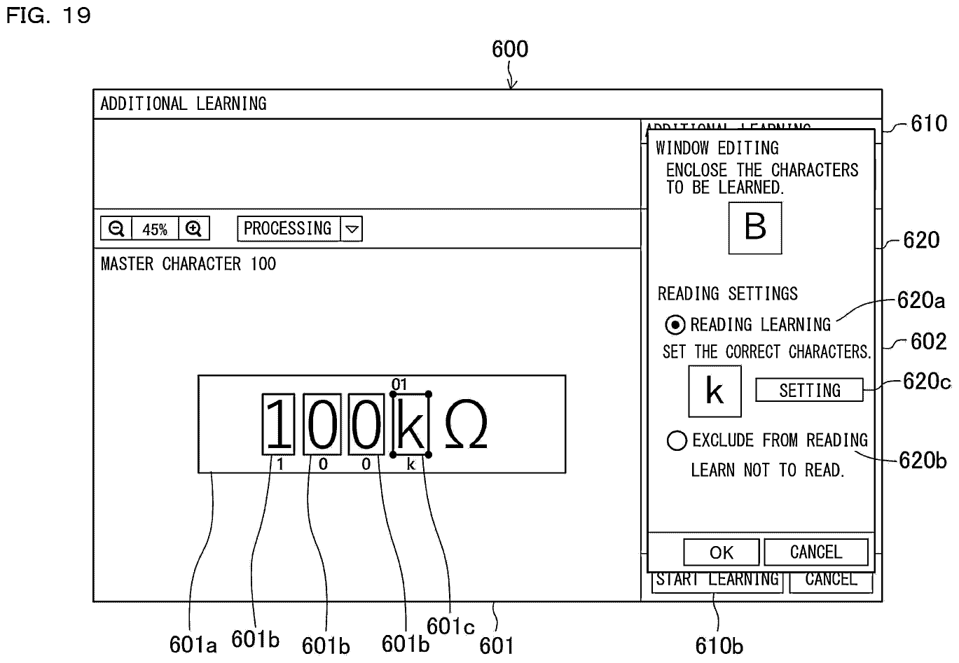

The control unit 21 identifies the character type selected by the user, and as shown in FIG. 19, displays the character type selected by the user in the character setting area 620a. This allows the user to confirm the character type they have selected.

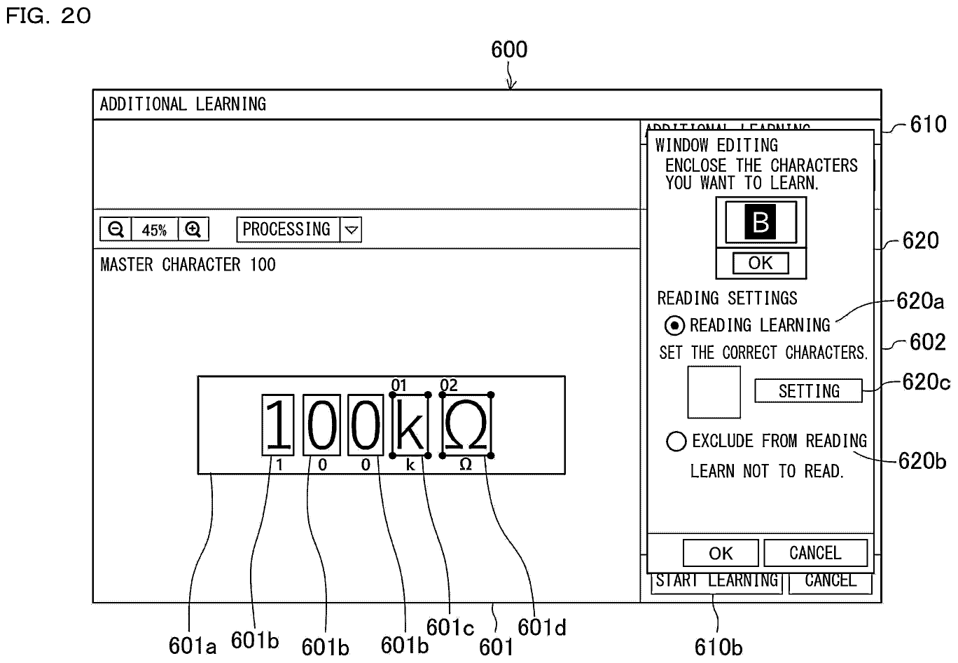

FIG. 20 shows an example of accepting the designation of a character type that is not registered in the image inspection device S, that is, an unregistered character type. If “Ω” is an unregistered character type in the image inspection device S, first, the user forms a fourth box 601d surrounding the character “Ω” that they want to learn on the image displayed in the operation result display area 601. The fourth box 601d can be formed in the same manner as the third box 601c.

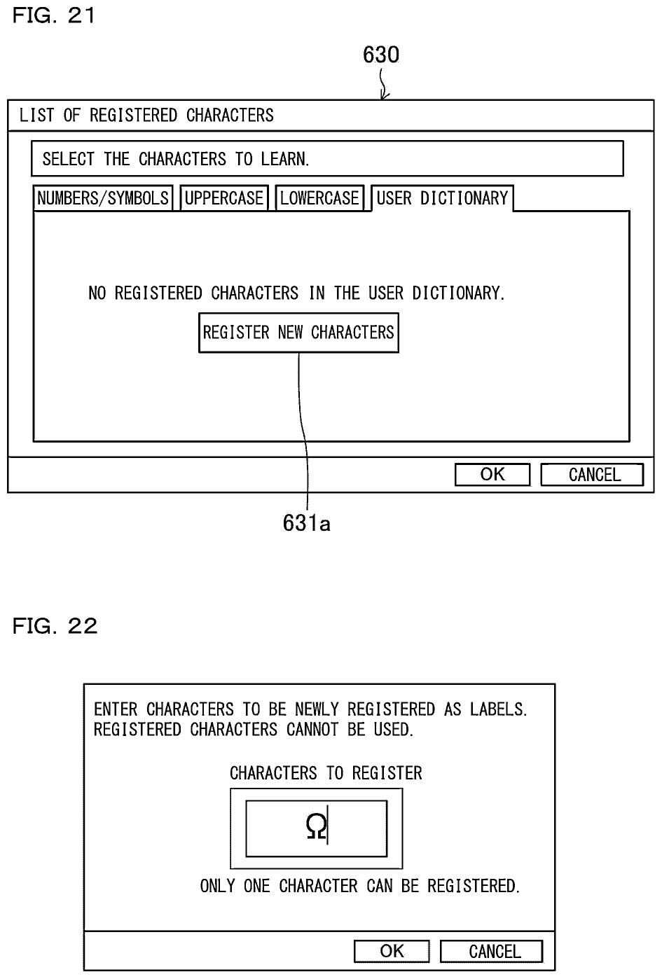

After the formation of the fourth box 601d, when the user operates the setting button 620c of the character setting area 620a, the control unit 21 generates and displays the character type selection window 630 shown in FIG. 21 on the display device 4. This example shows the case where no character types are registered in the user dictionary, and a new registration button 631a for newly registering character types is displayed.

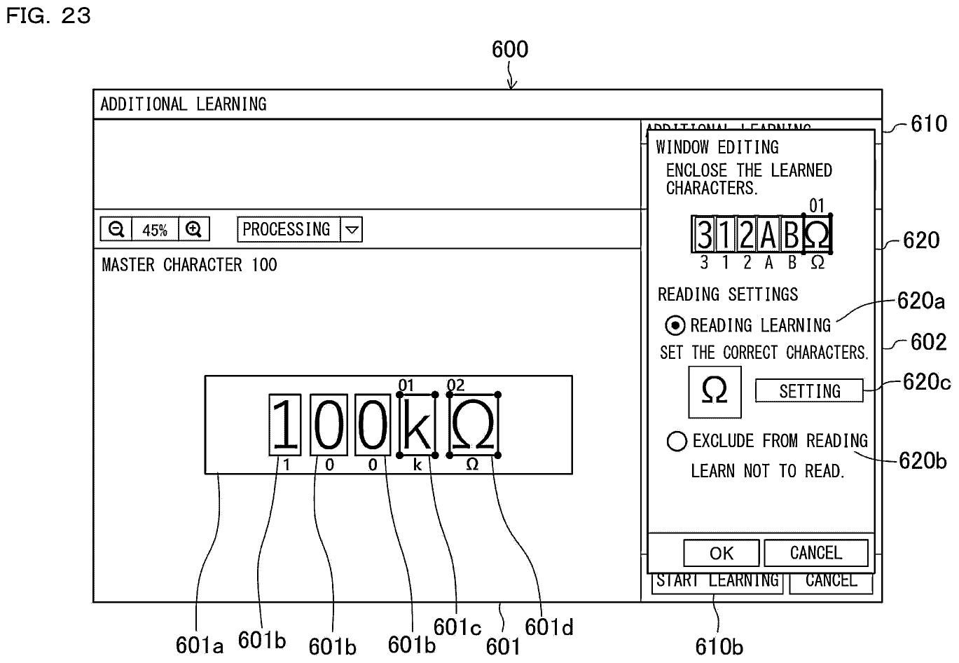

When the new registration button 631a is operated, the control unit 21 displays the new registration window 640 shown in FIG. 22. In the new registration window 640, only one character is accepted for input. However, if you want to input only one character from multiple characters that make up an idiom, you can first accept the input of the idiom and then allow the operation of deleting unnecessary characters to leave only the necessary character. This makes the character input operation easier. FIG. 23 shows the state where the input of “Ω” is completed.

After receiving the specification of the character type as described above, the process proceeds to step SD4 shown in FIG. 14.

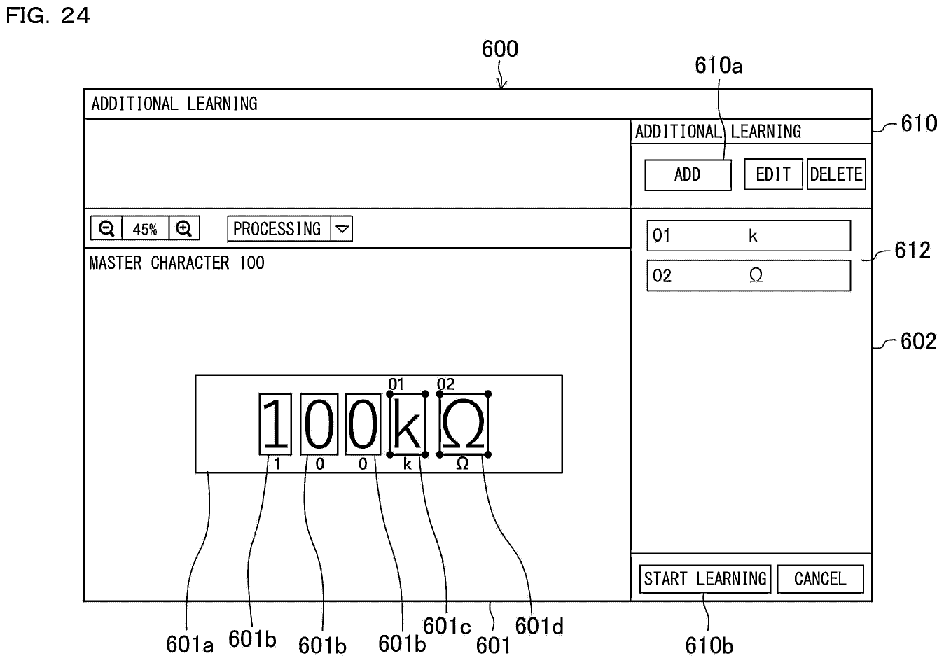

In step SD4, the control unit 21 receives the learning execution instruction from the user, but before receiving the learning execution instruction, the character types received in steps SD2 and SD3 are displayed in the character type display area 612 of the additional learning window 610 shown in FIG. 24. When the user operates the learning start button 610b, the process advances to step SD5 in FIG. 14, where the control unit 21 executes the additional learning of the model.

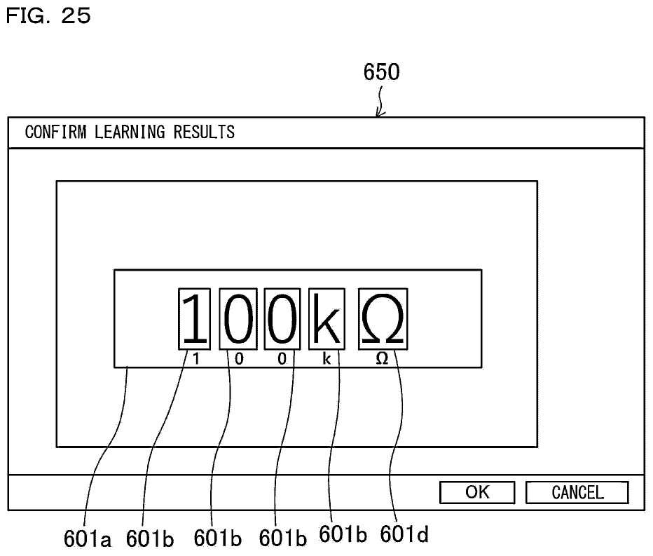

After step SD5, a test operation can be performed to evaluate the effect of additional learning. The control unit 21, upon receiving instructions for the test operation from the user, executes the process in which the character recognition model after additional learning classifies the input image area into character type classes. FIG. 25 shows an example of a result display screen 650 that displays the results of the test operation. This example indicates that the characters “k” and “Ω” that underwent additional learning have been classified. If there are misreadings during the test operation, the user can confirm this on the result display screen 650, allowing for corrections to be made at this stage for steps SD2 and SD3 in FIG. 14.

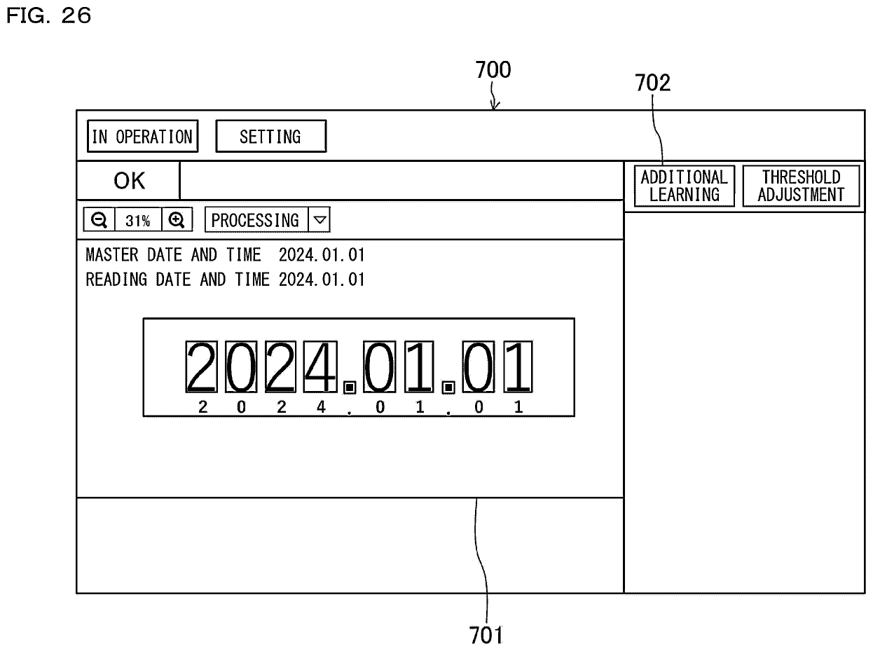

(Template Specification) FIG. 26 is a diagram showing an example of an operation screen 700 displayed during operation when inspecting the date printed or otherwise affixed to the work W. The operation screen 700 is a screen generated by the control unit 21 and displayed on the display device 4, and it is provided with an image display area 701 where the image input to the model is displayed and an additional learning button 702 for operating when performing additional learning. In the example shown in FIG. 26, the date is registered as a master. The image display area 701 is configured to display the master date and time and the reading date and time read by the model.

Here, for example, we assume a case where a workpiece W with a printed manufacturing date is inspected. If “Jan. 1, 2024” is registered as the master in the image inspection device S, the workpiece W manufactured on “Jan. 1, 2024” will be the inspection target. However, the workpiece W manufactured the next day will have “Jan. 2, 2024” printed on it, so if the master remains as “Jan. 1, 2024”, all workpieces W that are originally not problematic will be judged as “defective”. Therefore, the user needs to change the setting of the master date every day before operation, which is a significant burden. The same applies to expiration dates that change in relation to the manufacturing date.

In this embodiment, a template specification function is equipped. In the template specification function, for example, when the user specifies the format of the date, the image inspection device S automatically executes the date setting change using the current date and time information held internally. The specific setting method when using the template specification function will be explained below.

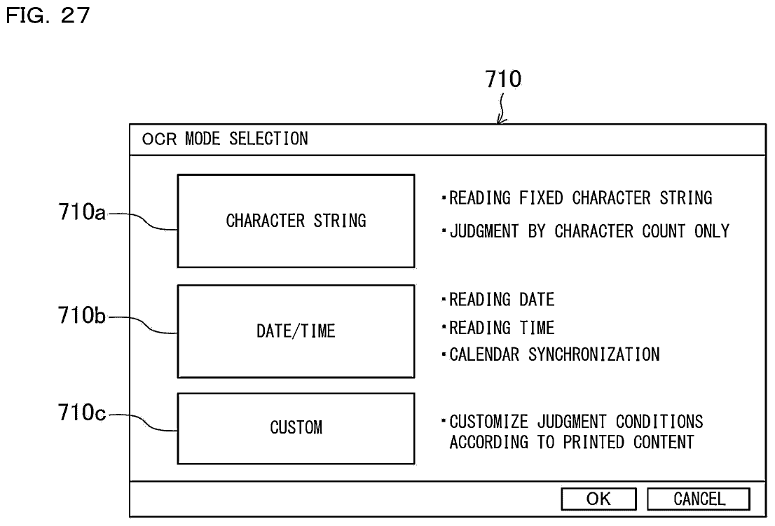

First, the control unit 21 generates a selection window 710 (shown in FIG. 27) that accepts the selection of the OCR mode and displays it on the display device 4. The selection window 710 is provided with a character string button 710a for selecting a character string mode suitable for reading fixed character strings (unchanging character strings), a date/time button 710b for selecting a date/time mode suitable for reading changing character strings such as dates and times, and a custom button 710c that allows customization of judgment conditions according to the printed content of the work W.

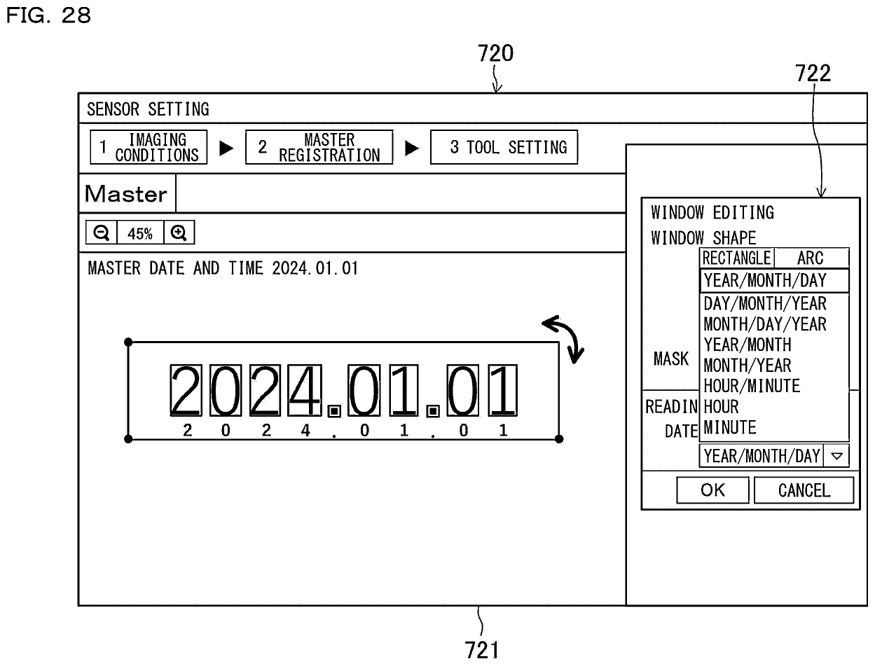

When the date/time button 710b is operated by the user, the control unit 21 generates the tool setting screen 720 as shown in FIG. 28 and displays it on the display device 4, and also generates the editing window 722 and displays it on the display device 4. The tool setting screen 720 is provided with an image display area 721 where the image input to the model is displayed. The editing window 722 displays options such as year/month/day, day/month/year, month/day/year, month/year, hour/minute, hour, and minute, and the user selects an option that matches the inspection target from these options.

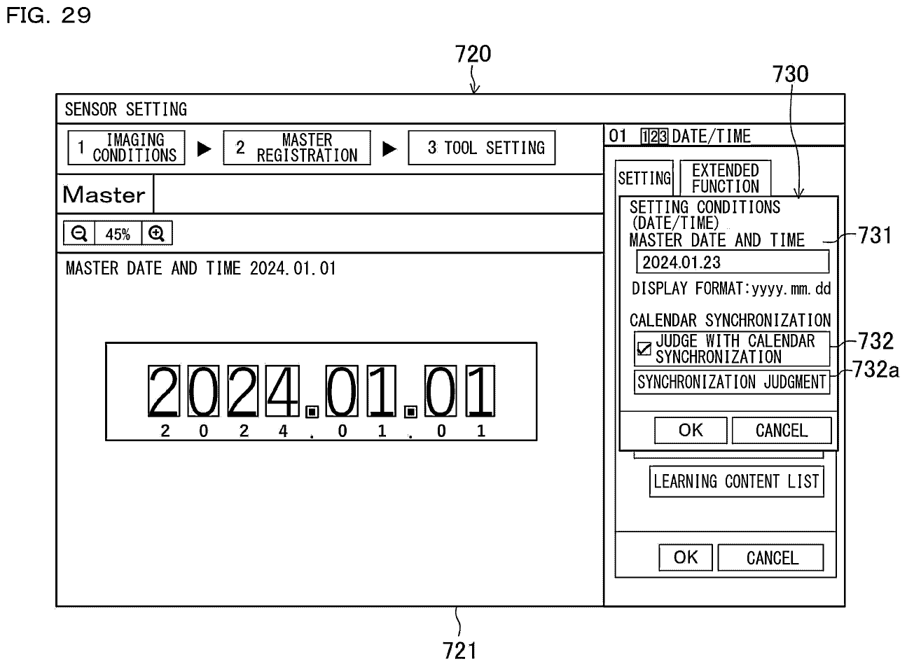

FIG. 29 shows a case where the user selects the year, month, and day. In this case, the control unit 21 generates and displays a judgment condition setting window 730 on the display device 4 for setting judgment conditions. The judgment condition setting window 730 is provided with a master date and time input area 731 for inputting the master date and time, and a synchronization setting area 732 for setting calendar synchronization. The date and time entered in the master date and time input area 731 is registered as the master. In the synchronization setting area 732, one can select between a synchronization mode that automatically executes date setting changes using the date and time information inside the image inspection device S, and an asynchronous mode that does not synchronize with the date and time information inside the image inspection device S. Changing the master date and time using the date and time information inside the image inspection device S is referred to as calendar synchronization. When the synchronization mode is selected, the control unit 21 acquires the date and time information inside the image inspection device S, and if the acquired date is determined to be the next day, the master date and time is automatically changed to the next day. The same applies to the time, where the control unit 21 acquires the time information inside the image inspection device S and automatically changes it to be the master time.

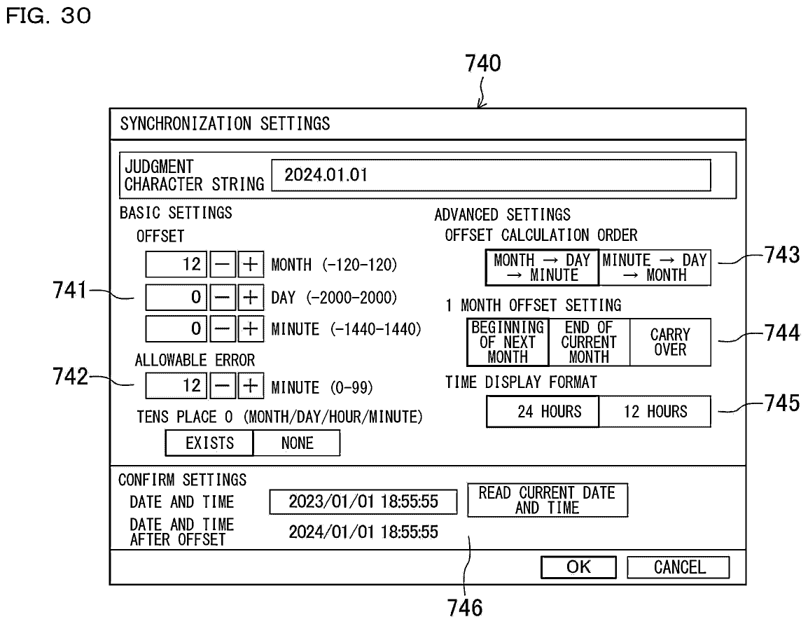

When the synchronization setting button 732a shown in FIG. 29 is operated, the control unit 21 generates the offset setting window 740 shown in FIG. 30 and displays it on the display device 4. The offset setting window 740 is a window for accepting the setting of the offset amount when the user wants to offset the registered date and time as a master by a predetermined date and time. The offset setting window 740 is provided with a setting area 741 that allows the offset amount to be set in months, days, and minutes, an allowable error setting area 742 for setting the range that can be tolerated as an error, a calculation order setting area 743 for setting the calculation order of the offset, a one-month offset setting area 744, a time display format setting area 745, and a setting confirmation area 746. With this offset setting window 740, the user can easily set any offset amount. For example, as shown in the setting confirmation area 746, if the manufacturing date is “Jan. 1, 2023,” when offsetting by 12 months, it can be confirmed that the master is “Jan. 1, 2024.” The set offset amount is reflected in the master by the control unit 21.

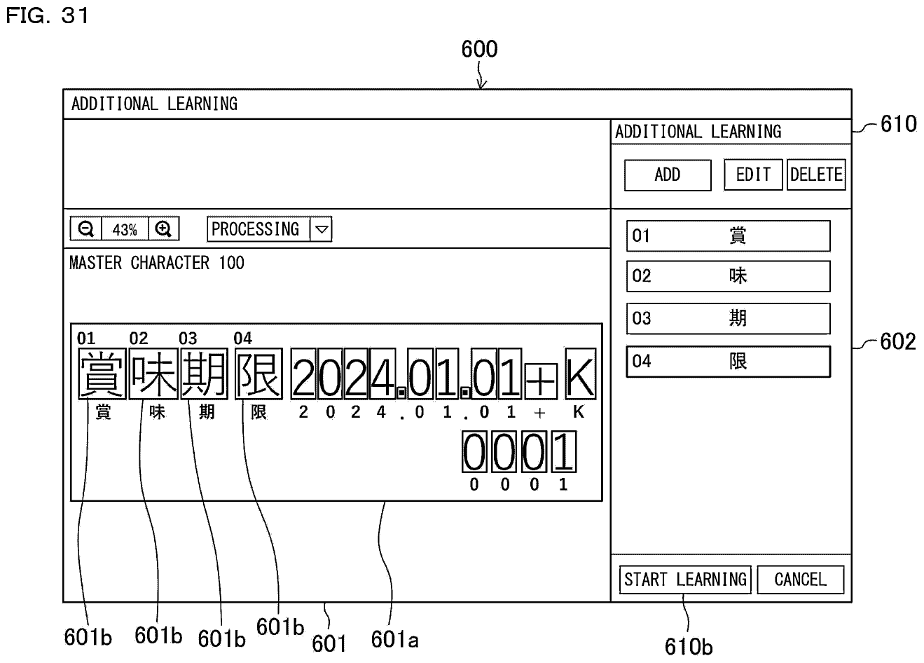

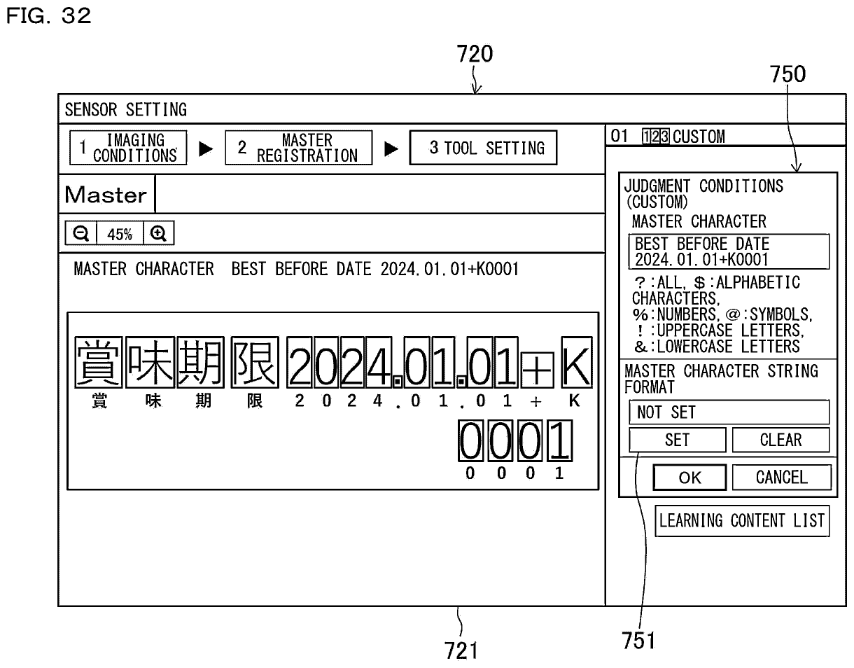

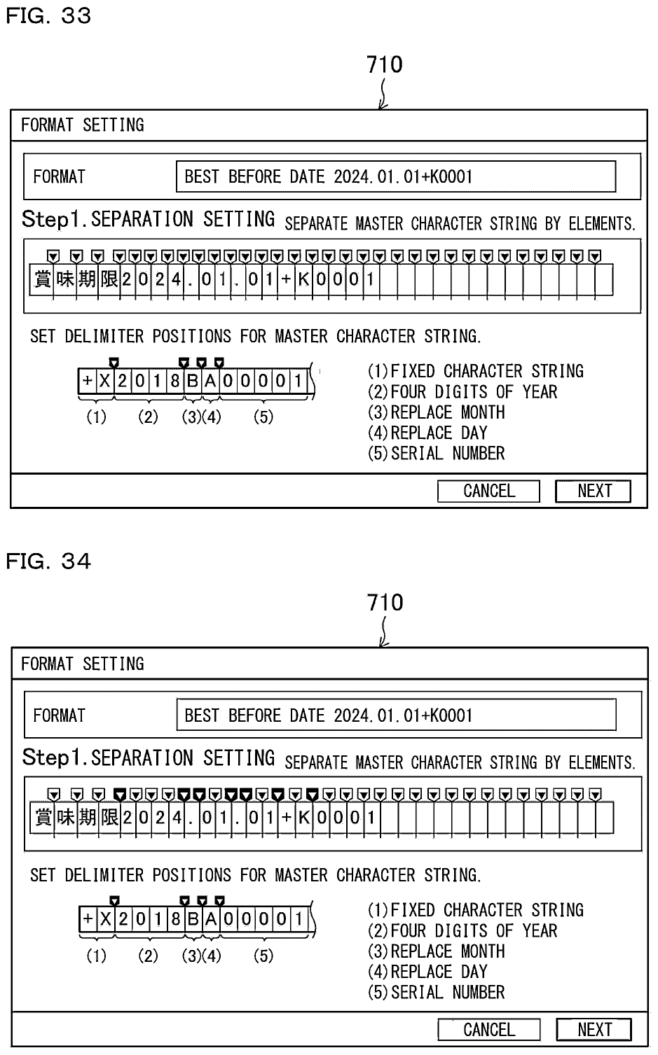

(Custom Setting) The image inspection device S may be configured to allow custom settings by the user when template designation cannot be accommodated. FIG. 31 is a diagram explaining the case where the master string changes for each imaging, and among the images displayed in the operation result display area 601, the “0001” in the bottom right is a count-up type master string that increases by one for each imaging, which is similar to a manufacturing number. In such a case of the master, the user operates the custom button 710c in the selection window 710 shown in FIG. 27. Then, the control unit 21 generates and displays a judgment condition setting window 750 for setting the judgment conditions for custom settings, as shown in FIG. 32, on the display device 4. The judgment condition setting window 750 is provided with a setting button 751 for executing format settings. When the setting button 751 is operated, the control unit 21 generates and displays a format setting window 770 on the display device 4, as shown in FIG. 33. The format setting window 770 is provided with a separation setting area 771 for separating the master string by elements. In the example shown in FIG. 33, the character string consists of eight elements: “best before date”, “2024”, “.”, “01”, “.”, “01”, “+K”, and “0001”. In this case, as shown in FIG. 34, a separation is set between “best before date” and “2024”, between “2024” and “.”, between “.” and “01”, between “01” and “.”, between “.” and “01”, between “01” and “+K”, and between “+K” and “0001”. When setting the separation, it is sufficient to perform an operation to select a mark indicating the separation.

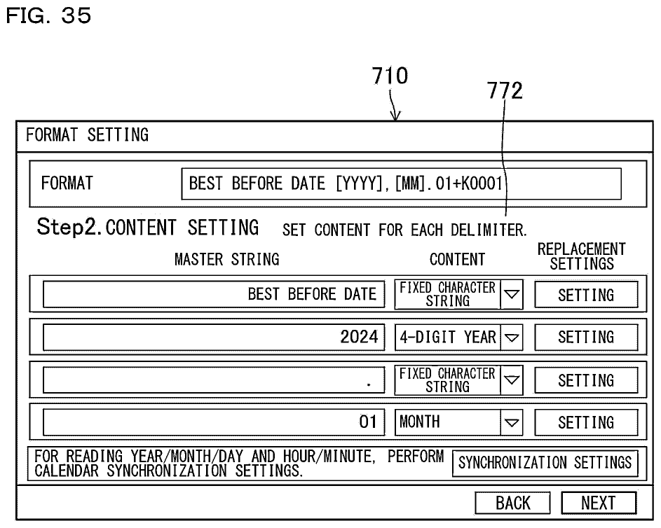

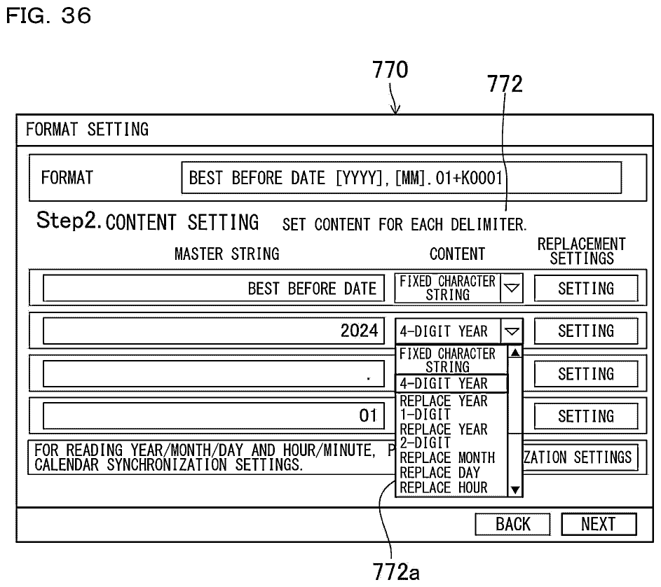

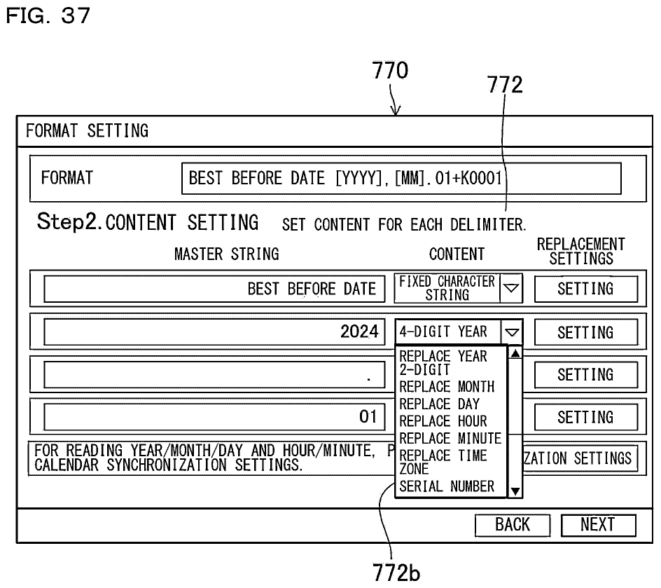

After separating the master string into elements, the content can be specified for each element. After the separation is complete, as shown in FIG. 35, the format setting window 770 displays the content setting area 772. In the content setting area 772, multiple elements are listed, and when the user performs an operation to select one element, the first selection window 772a shown in FIG. 36 or the second selection window 772b shown in FIG. 37 is displayed. The user can select the desired content from the multiple options shown in the first selection window 772a or the second selection window 772b. The selected content is reflected in the master. At this time, when synchronizing with the calendar, the offset setting window 740 shown in FIG. 30 is displayed on the display device 4, allowing for the setting of the offset amount.

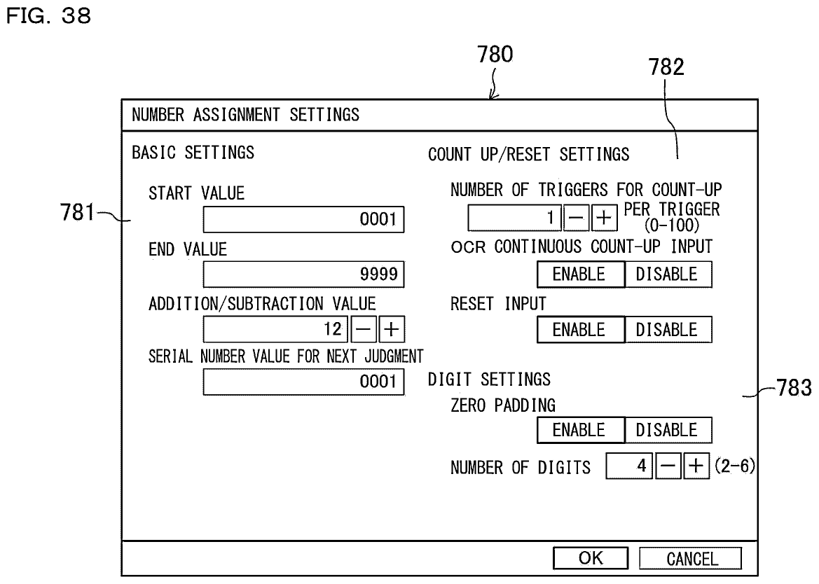

Moreover, when the element is a count-up type string or a count-down type string, the control unit 21 generates a count-up/down setting window 780 as shown in FIG. 38 and displays it on the display device 4. The count-up/down setting window 780 is provided with a basic setting area 781, a count-up/reset setting area 782, and a digit number setting area 783. In the basic setting area 781, the start value, end value, addition/subtraction value, and serial number value can be set. In the count-up/reset setting area 782, settings such as the trigger count can be made. In the digit number setting area 783, it is possible to enable or disable zero padding and set the number of digits.

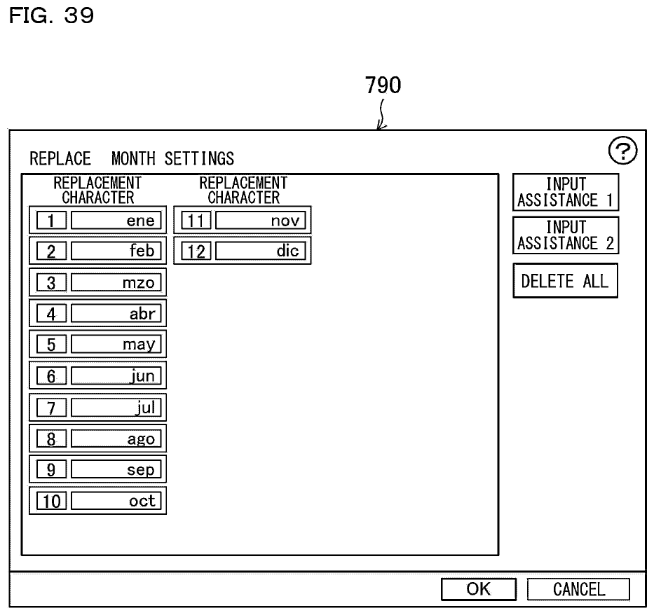

FIG. 39 shows the replacement settings window 790. In this replacement settings window 790, it is possible to link the display of the corresponding month for each country with the calendar. This allows for accommodating different languages and date formats depending on the country.

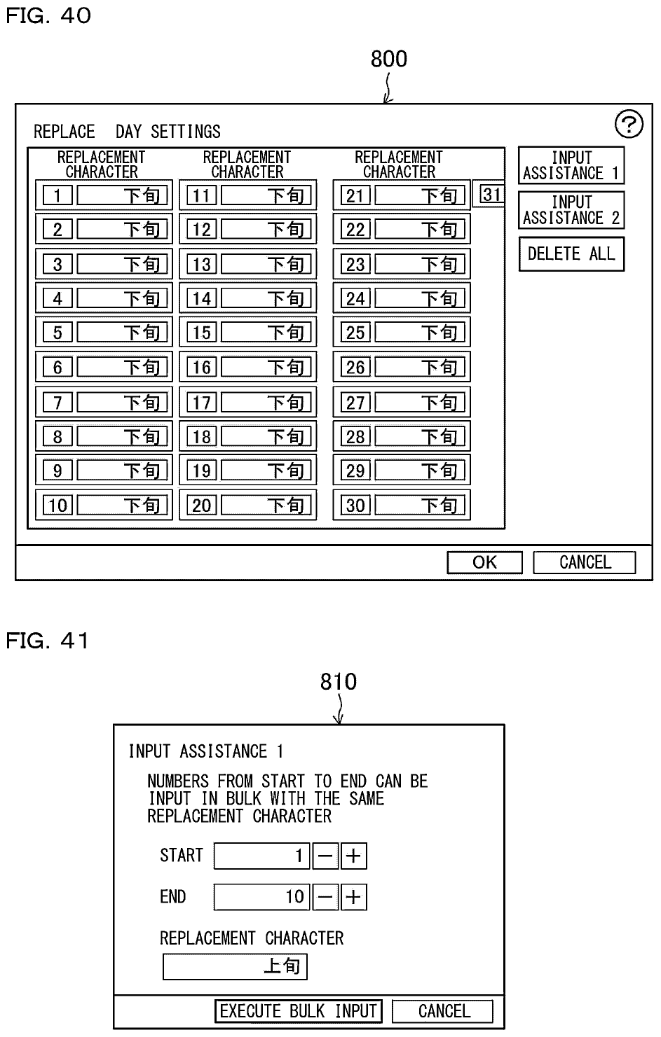

FIG. 40 shows a linking window 800 for linking the representations of early part of the month, middle part of the month, and latter part of the month with the calendar. In the linking window 800, when setting to link the representations of early part of the month, middle part of the month, and latter part of the month with the calendar, it is possible to input the same input items such as early part of the month, middle part of the month, and latter part of the month in bulk using a bulk input window 810 as shown in FIG. 41.

(OCR circumference Search Function)

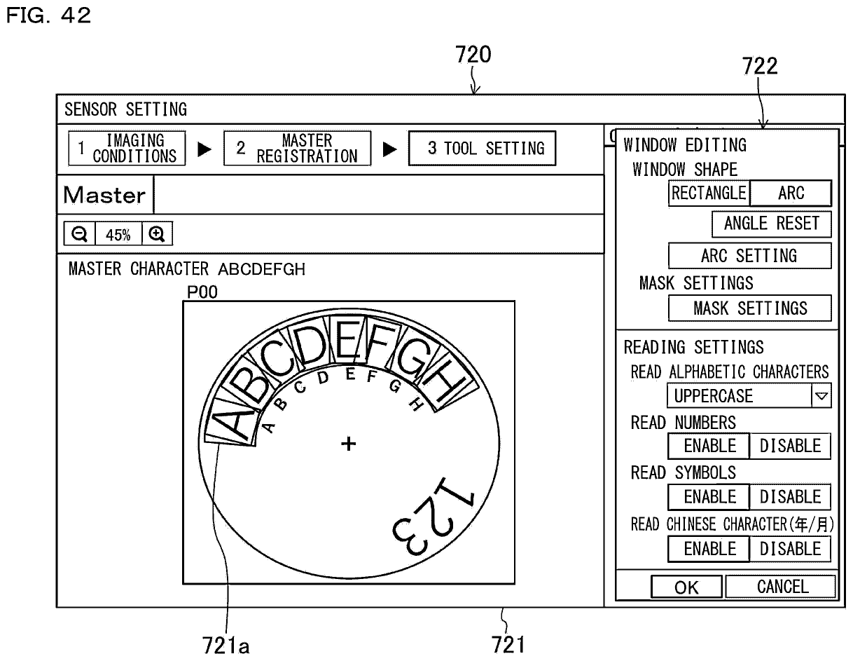

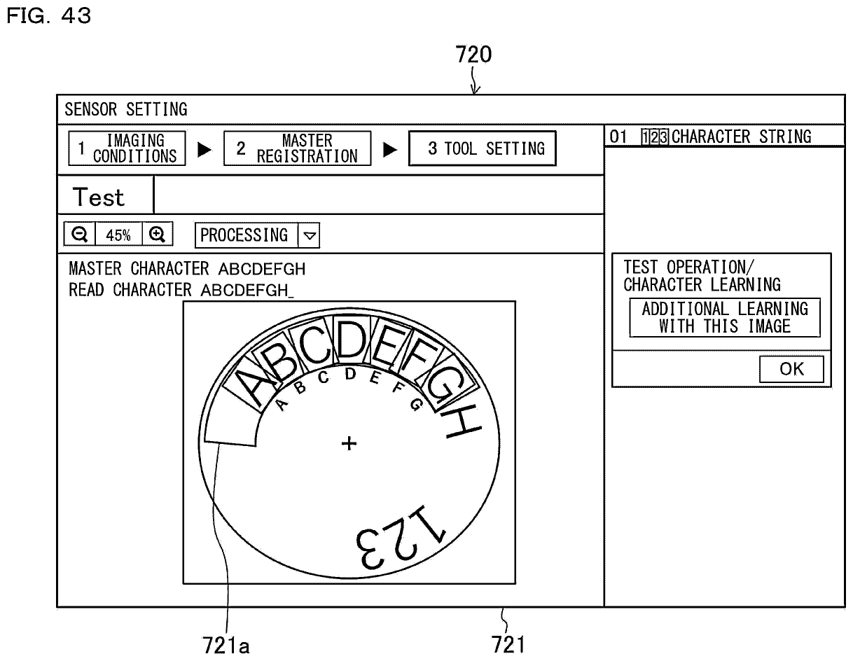

As shown in FIG. 42, there are cases where multiple characters included in the image are arranged in an arc shape. In this embodiment, instead of setting one tool for each character, it is possible to specify the character image and input it into the model, so in the editing window 722, by specifying “arc,” it becomes possible to specify the string range 721a arranged in an arc shape. However, as shown in FIG. 43, there are cases where an image with a changed phase of the string arranged in an arc shape is input. In general position correction tools, the center position of the circle can be positioned, but the positioning of the phase cannot be done, so the string to be detected may fall outside the string range 721a.

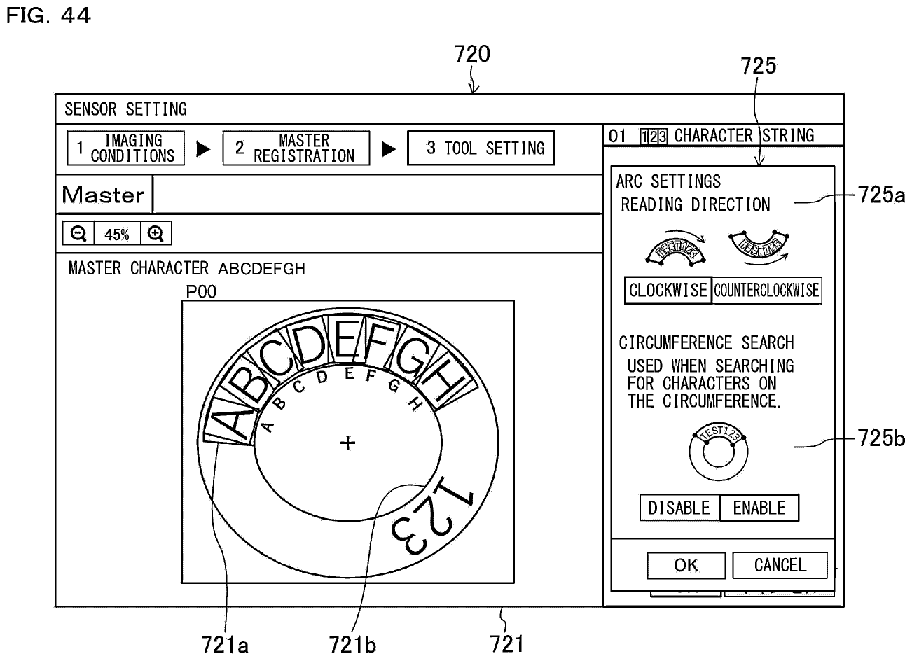

In response to this, the image inspection device S is capable of handling cases where the phase of the character string arranged in an arc shape changes, by using the OCR circumference search function. Specifically, as shown in FIG. 44, the control unit 21 generates and displays an arc setting window 725 on the display device 4. The arc setting window 725 is provided with a reading direction specification area 725a for specifying whether the reading direction is clockwise or counterclockwise, and a circumference search setting area 725b for setting whether to enable the circumference search function. When the circumference search is enabled in the circumference search setting area 725b, a circular search range 721b is displayed in the image display area 721, separate from the character string range 721a.

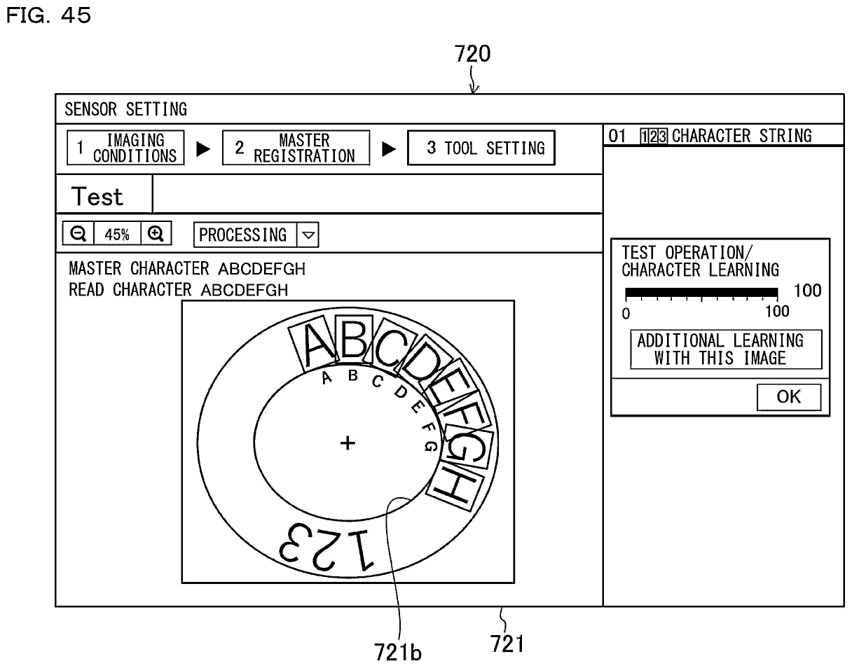

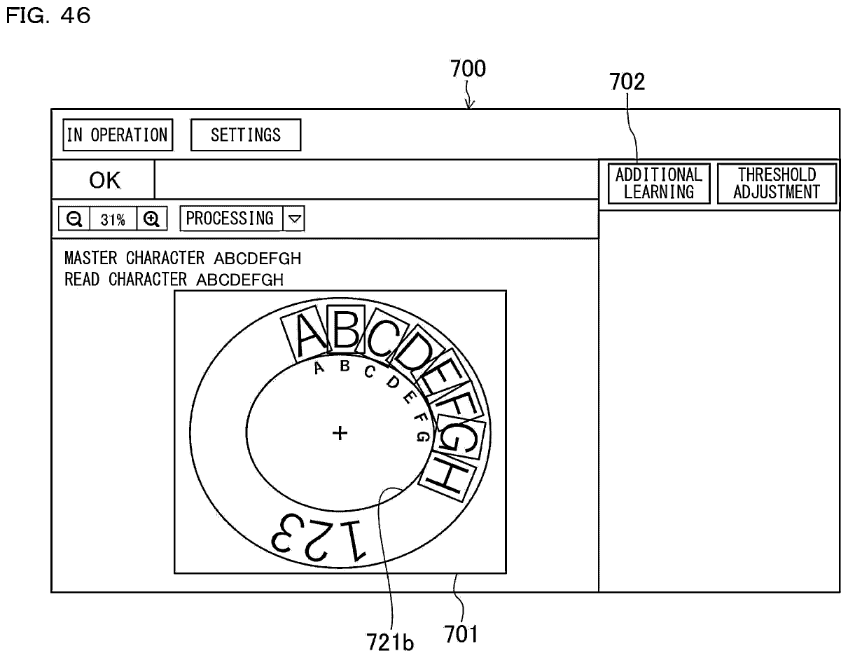

FIG. 45 shows test images with different phases of character strings, and additional learning can be performed using such test images. As shown in FIG. 46, even if images with different phases of character strings are input during the operation of the image inspection device S, inspection becomes possible.

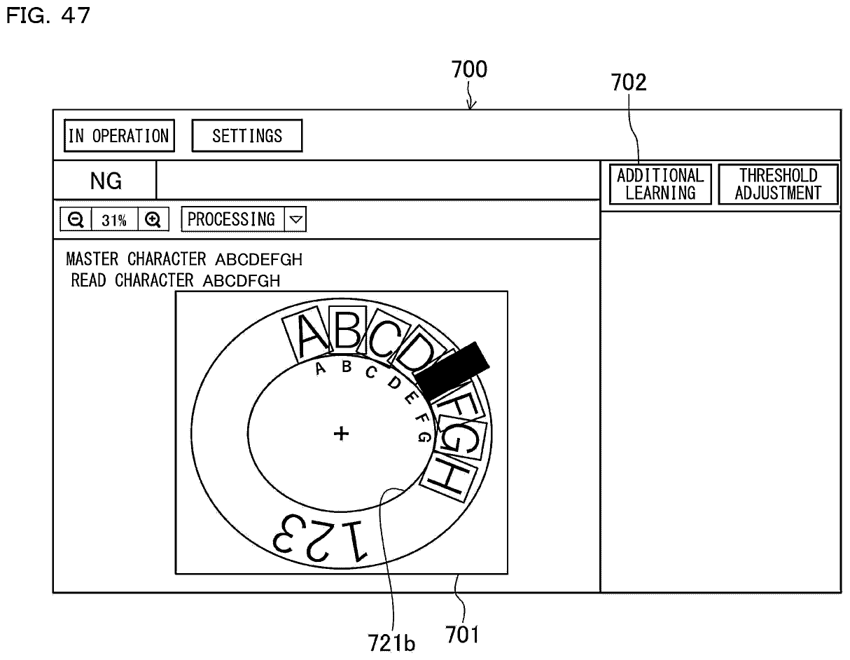

FIG. 47 shows a case where a part of the character string arranged in an arc shape registered as a master is missing, resulting in a defective inspection result. In such cases of missing data, the model is configured to read out character strings that have a close edit distance.

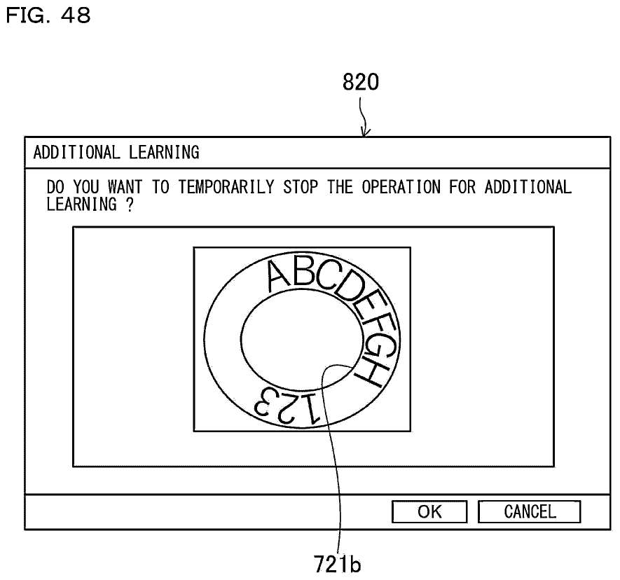

FIG. 48 is an image showing an additional learning confirmation window 820 that confirms whether or not to perform additional learning with the image when an image with different phases of a character string arranged in an arc shape is input. The user can select OK to perform additional learning with the image displayed in the additional learning confirmation window 820, or select Cancel if they do not wish to perform additional learning.

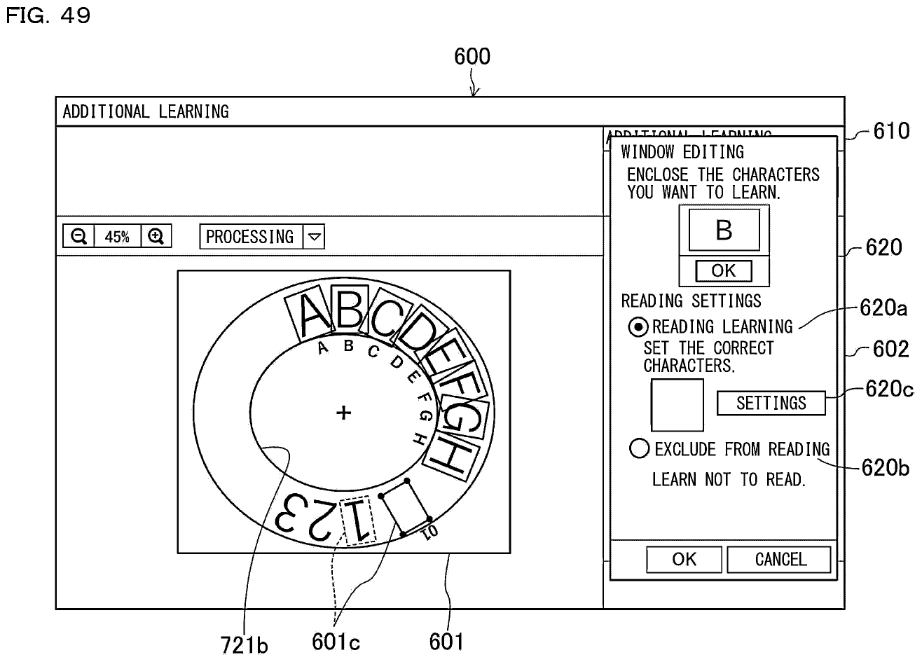

FIG. 49 is a diagram explaining the case where the third box 601c, which surrounds the characters to be learned during additional learning, is moved. When the user moves the third box 601c, the movement direction of the third box 601c is set so that it automatically moves along the circular search range 721b. This allows the third box 601c to be easily moved in the desired direction. When reading a string of characters arranged in an arc shape with the model, reading is executed after expanding it into a rectangular strip.

The aforementioned embodiments are merely illustrative in all respects and should not be interpreted restrictively. Furthermore, any modifications or changes that fall within the equivalent range of the patent claims are all within the scope of the present invention.

### INDUSTRIAL APPLICABILITY

As described above, the image inspection device according to the present disclosure can be used for inspecting various works.

What is claimed is:

1. An image inspection device in which a pre-trained character recognition model is executed to classify an image area, which is a partial area in an input image data, into a first character type class, comprising:
a control unit configured to execute the pre-trained character recognition model and to function as a learning data generation unit configured to generate learning data and a learning execution unit configured to execute updating of the pre-trained character recognition model based on the learning data, wherein
the pre-trained character recognition model includes:
a feature extraction unit configured to extract a feature from the input image data, the feature indicating a characteristic of an image data, and
a character type output unit configured to output a character type based on the feature extracted by the feature extraction unit,
the learning data generation unit generates the learning data that includes learning image data, specified position information indicating a relative position of a character in an image of the learning image data, specified character type information indicating the character type of the character located at the relative position, and specified size information indicating a size of the character in the image,
the learning execution unit updates the pre-trained character recognition model so as to classify the feature, the feature being extracted in a case that the learning image data is input to the feature extraction unit and corresponding to the relative position indicated by the specified position information, into a specified character type class corresponding to a combination of the character type indicated by the specified character type information and the size indicated by the specified size information.

2. The image inspection device described in claim 1, wherein:
the control unit includes a convolutional operation network inference accelerator configured to perform operations of a convolutional neural network as the feature extraction unit.

3. The image inspection device described in claim 1, wherein:
the feature extraction unit includes;
a character type class feature extraction unit configured to extract the character type class feature, the character type class feature being the feature related to a character type class of the image area, and
a foreground-background feature extraction unit configured to extract a foreground feature indicating whether the image area is foreground or background,
the pre-trained character recognition model includes a foreground output unit configured to determine whether the image area is foreground based on the foreground feature; and
the character type output unit outputs a value indicating the character type of the image area corresponding to the image area determined as foreground by the foreground output unit.

4. The image inspection device described in claim 1, wherein:
the feature extraction unit includes;
a character type class feature extraction unit configured to extract the character type class feature, the character type class feature being the feature related to a character type class of the image area, and
a size feature extraction unit configured to extract a size feature, the size feature being the feature related to the size of the image area; and
the character type output unit outputs the size of the image area based on the specified size information included in the specified character type class, when the character type class feature belongs to the specified character type class corresponding to the combination of the character type and the size.

5. The image inspection described in claim 4, wherein:
the pre-trained character recognition model includes a size output unit configured to output the size of the image area based on the size feature; and
the size output unit outputs the size of the image area, when the character type class feature does not belong to the specified character type class corresponding to the combination of the character type and the size.
